(19) United States
(12) Patent Application Publication
(10) Pub. No.: US 2019/0017486 A1
(43) Pub. Date: Jan. 17, 2019

(54) CONTROL SYSTEM OF VEHICLE AND CONTROL METHOD OF THE SAME

(71) Applicant: TOYOTA JIDOSHA KABUSHIKI KAISHA, Toyota-shi (JP)

(72) Inventor: Ken Kuretake, Mishima-shi (JP)

(73) Assignee: TOYOTA JIDOSHA KABUSHIKI KAISHA, Toyota-shi (JP)

(21) Appl. No.: 16/011,042

(22) Filed: Jun. 18, 2018

(30) Foreign Application Priority Data
Jul. 11, 2017 (JP) 2017-135172

(51) Int. Cl. F02N 11/08; B60W 30/18; B60W 10/06; B60W 50/14

(52) U.S. Cl. CPC F02N 11/0837; B60W 30/18018; B60W 2050/143; B60W 50/14; B60W 2550/308; B60W 10/06

(57) ABSTRACT

A control system of a vehicle has an automatic stop and restart function to automatically stop an engine when automatic stop conditions are fulfilled, and restart the engine when normal restart conditions are fulfilled during automatic stop of the engine, and a notifying function to notify a driver of starting of a preceding vehicle, when an intervehicular distance from the preceding vehicle during stopping becomes equal to or larger than a first predetermined distance. The automatic stop and restart function includes a synchronous restart function of restarting the engine, in synchronization with notification by the notifying function, even when the normal restart conditions are not fulfilled. When notification fixation is detected, the synchronous restart function is restricted, and restart of the engine is inhibited until the normal restart conditions are fulfilled.

### INCORPORATION BY REFERENCE

The disclosure of Japanese Patent Application No. 2017-135172 filed on Jul. 11, 2017 including the specification, drawings and abstract is incorporated herein by reference in its entirety.

### BACKGROUND

### 1. Technical Field

The disclosure relates to a control system of a vehicle and a control method of the control system, and in particular to a control system installed on a vehicle having an automatic stop and restart function and a notifying function, and a control method of the control system.

### 2. Description of Related Art

A vehicle having an automatic stop and restart function for improvement of the fuel efficiency is known in the art. The automatic stop and restart function is to cause an engine to be automatically stopped when predetermined automatic stop conditions are fulfilled, and cause the engine to be restarted when predetermined restart conditions are fulfilled during automatic stop of the engine.

In the above type of vehicle, a condition of brake OFF (for example, release of the driver's foot from a brake pedal) is included as one of the restart conditions. However, if the driver is not aware of starting of a preceding vehicle, and performs brake-OFF operation (e.g., releases the brake pedal) with a delay, the engine is restarted, following the delayed brake OFF, and then the own vehicle starts. Through this process, a delay arises in engine start-up when the vehicle starts, which may be one factor of traffic congestion.

In view of the above situation, an engine control system as described in Japanese Patent Application Publication No. 2006-316644 (JP 2006-316644 A), for example, is configured to stop the engine that is in an idling state, when predetermined stop conditions are satisfied, and automatically restart the engine, when the amount of change in the intervehicular distance from the preceding vehicle becomes equal to or larger than a predetermined amount, and the system determines that the preceding vehicle has started.

### SUMMARY

In the meantime, a notifying function of notifying a driver of an own vehicle of starting of a preceding vehicle when the preceding vehicle starts during stopping of the own vehicle is also known in the art. The notifying function is to notify the driver of starting of the preceding vehicle via a display or a buzzer, when the intervehicular distance between the own vehicle and the preceding vehicle becomes equal to or larger than a predetermined value set by the driver.

Then, if the function of restarting the engine based on the intervehicular distance from the preceding vehicle, as described in JP 2006-316644 A, for example, is combined with the notifying function as described above, automatic restart of the engine and notification of starting of the preceding vehicle may be carried out at the same time. As a result, a delay in start-up at the time of engine restart can be reduced, and the driver can be notified of starting of the preceding vehicle. This makes it possible to start the vehicle in appropriate timing, which contributes to alleviation or reduction of traffic congestion.

In the above type of vehicle, however, the notifying function may not be normally activated due to a malfunction, or the like, of a notifying system, for example. More specifically, the notification output may be held in the ON state before the engine is automatically stopped (which will be called “ON fixation”), or the notification output may be set to ON before the intervehicular distance becomes equal to or larger than the predetermined value after automatic stop of the engine (which will be called “early ON fixation”), or the notification output may be set to ON with a delay from the time when the intervehicular distance becomes equal to or larger than the predetermined value after automatic stop of the engine (which will be called “delayed ON fixation”), or the notification output may be kept in the OFF state (which will be called “OFF fixation”), for example. The above-mentioned “early ON fixation”, “ON fixation”, “delayed ON fixation”, and “OFF fixation” may be collectively called “notification fixation”.

If the notification fixation as described above occurs, the engine may be automatically restarted even in the absence of starting of the preceding vehicle or notification, or the engine may not be restarted even though the preceding vehicle starts, depending on the manner of combining the function of restarting the engine based on the intervehicular distance from the preceding vehicle, with the notifying function. Thus, restarting of the engine may suffer from instability.

The disclosure has been developed in view of the above points, and provides a technology of reducing instability in restarting of the engine, while providing starting assistance in appropriate timing, in a control system of a vehicle having an automatic stop and start function and a notifying function, and its control method.

In the control system of the vehicle and its control method according to the disclosure, when notification fixation is detected, the function of restarting the engine along with notification is restricted.

According to one aspect of the disclosure, there is provided a control system of a vehicle, which includes an electronic control unit configured to (i) have an automatic stop and restart function to automatically stop an engine when a predetermined automatic stop condition is fulfilled, and restart the engine when a predetermined restart condition is fulfilled during automatic stop of the engine, and (ii) have a notifying function to notify a driver of an own vehicle that a preceding vehicle has started, by setting notification output to ON when an intervehicular distance between the own vehicle that is stopped and the preceding vehicle becomes equal to or larger than a first predetermined distance.

The automatic stop and restart function includes a synchronous restart function, and the electronic control unit is configured to restrict the synchronous restart function, and inhibit the engine from restarting until the predetermined restart condition is fulfilled, when notification fixation with which the notification output is placed in an ON state or an OFF state in a situation other than a preset setting situation is detected. The synchronous restart function is a function of restarting the engine that is automatically stopped, in synchronization with notification by the notifying function, even when the predetermined restart condition is not fulfilled.

According to another aspect of the disclosure, there is provided a control method of a control system of a vehicle as follows. Namely, the control method includes (i) automatically stopping an engine when a predetermined automatic stop condition is fulfilled, and restarting the engine when a predetermined restart condition is fulfilled during automatic stop of the engine, (ii) notifying a driver of an own vehicle that a preceding vehicle has started, by setting notification output to ON when an intervehicular distance between the own vehicle that is stopped and the preceding vehicle becomes equal to or larger than a first predetermined distance, (iii) performing a synchronous restart function of restarting the engine that is automatically stopped, in synchronization with notification by the notifying function, even when the predetermined restart condition is not fulfilled, and (iv) restricting the synchronous restart function, and inhibiting the engine from restarting until the predetermined restart condition is fulfilled, when notification fixation with which the notification output is placed in an ON state or an OFF state in a situation other than a preset setting situation is detected.

In the above aspects of the disclosure, examples of the “preset setting situation” include a setting situation where notification output is generated when the intervehicular distance between the own vehicle that is stopped and the preceding vehicle becomes equal to or larger than a predetermined distance A, and a setting situation where notification output continues to be generated while the traveling distance of the own vehicle after engine restart is smaller than a predetermined distance AA, for example. Then, examples of the case where “notification output is placed in an ON state or an OFF state in a situation other than the preset setting situation” include the case where, under a setting situation where notification output is generated when the intervehicular distance is equal to or larger than the predetermined distance A, the notification output is placed in the ON state when the intervehicular distance is smaller than the predetermined distance A, or the notification output is kept in the OFF state even when the intervehicular distance becomes equal to or larger than a predetermined distance B (>A), for example. The above examples may also include the case where, under a setting situation where the notification output continues to be generated while the traveling distance is smaller than a predetermined distance L2, the notification output is kept in the ON state even when the traveling distance is equal to or larger than the predetermined distance L2.

With the above configuration, when the intervehicular distance from the preceding vehicle becomes equal to or larger than the first predetermined distance, the notification output is set to ON, and the engine is restarted, in synchronization with the notification by the notifying function, even when the predetermined restart condition (e.g., brake OFF) is not fulfilled. Thus, even when the driver is not aware of starting of the preceding vehicle, it is possible to reduce a delay in start-up at the time of engine restart, and cause the driver to be aware of starting of the preceding vehicle, so that starting assistance can be performed in appropriate timing.

In this connection, if ON fixation or OFF fixation occurs, for example, the engine may be automatically restarted even in the absence of starting of the preceding vehicle or notification, or the engine may not be automatically restarted even though the preceding vehicle starts. As a result, engine restart may be unstably performed, and the driver may feel strange or uncomfortable. In this respect, according to this disclosure, when any notification fixation is detected, the function (synchronous restart function) of restarting the engine in synchronization with notification is restricted, and the engine is inhibited from restarting until the predetermined restart condition is fulfilled, in other words, the engine is restarted in response to brake-OFF operation, or the like, by the driver. It is thus possible to reduce instability with which the engine is restarted, and suppress the strange feeling or uncomfortableness of the driver.

Here, examples of the mode in which “the engine that is automatically stopped is restarted in synchronization with notification by the notifying function, even when the predetermined restart condition is not fulfilled” may include a mode (1) in which engine restart depends on ON (generation) of the notification output, and a mode (2) in which engine restart does not depend on ON (generation) of the notification output.

More specifically, as an example of the mode (1), the engine is restarted, under a condition (which will be called “notification restart condition”) that the notification output is set to ON, separately from the predetermined restart condition (which may also be called “normal restart condition”).

On the other hand, as an example of the mode (2), the engine is restarted under a condition of a certain event P, separately from the normal restart condition, and the notification output is set to ON under the condition of the same event P. Thus, the engine restart and ON (generation) of the notification output are performed at the same time (at the time of occurrence of the event P), while the engine restart based on the automatic stop and restart function, and the notification based on the notifying function, are controlled independently of each other.

Thus, in the mode (1), the electronic control unit, when performing the synchronous restart function, may be configured to (i) restart the engine when the notification output by the notifying function is set to ON, and (ii) detect the notification fixation, when the notification output is set to ON, even though the intervehicular distance between the own vehicle that is stopped and the preceding vehicle is smaller than the first predetermined distance.

With the configuration of the control system of the vehicle as described above, the synchronous restart function included in the automatic stop and restart function causes the engine to be restarted when the notification output is set to ON. Therefore, even when the brake is ON (i.e., is applied), the engine can be restarted in synchronization with the notification by the notifying function, under the condition that the notification output is set to ON.

In the mode (1), the ON timing of the notification output always coincides with the timing of engine restart, unlike the mode (2). Therefore, when the early ON fixation occurs such that the notification output is set to ON before the intervehicular distance becomes equal to or larger than the first predetermined distance, the engine is restarted even when the preceding vehicle has not started, for example, and the engine automatic stop period may become relatively short, thus making it difficult to ensure an opportunity of improvement of the fuel efficiency.

In this respect, according to the disclosure, the notification fixation (early ON fixation) is detected, when the notification output is set to ON even though the intervehicular distance between the own vehicle that is stopped and the preceding vehicle is smaller than the first predetermined distance. As a result, the synchronous restart function of restarting the engine under the condition that the notification output is set to ON is restricted. Thus, the engine is inhibited from restarting until the normal restart condition (e.g., brake OFF) is satisfied, and the opportunity of improvement of the fuel efficiency can be ensured.

In the control system as described above, in the mode (1), the electronic control unit, when performing the synchronous restart function, may be configured to (i) restart the engine when the notification output by the notifying function is set to ON, and (ii) detect the notification fixation, when the notification output is kept in the ON state even when a traveling distance of the own vehicle after restart of the engine becomes equal to or larger than a third predetermined distance.

In the mode (1), the ON timing of the notification output always coincides with the timing of engine restart, unlike the mode (2). Therefore, when the ON fixation with which the notification output is kept in the ON state occurs before automatic stop of the engine, the engine is restarted immediately after the engine is automatically stopped, and the fuel efficiency may deteriorate due to the brief automatic stop of the engine.

In this respect, according to the disclosure, the notification fixation (ON fixation) is detected, when the notification output is kept in the ON state even when the traveling distance of the own vehicle after engine restart becomes equal to or larger than the third predetermined distance. As a result, the synchronous restart function is restricted. Thus, when the engine is automatically stopped after detection of the notification fixation, the engine is inhibited from restarting until the normal restart condition is satisfied. It is thus possible to curb deterioration of the fuel efficiency due to otherwise possible brief automatic stop of the engine.

When the delayed ON fixation occurs such that the notification output is set to ON with a delay from the time when the intervehicular distance becomes equal to or larger than the first predetermined distance, or the OFF fixation occurs such that the notification output is kept in the OFF state, the engine restart in response to fulfillment of the normal restart condition may be performed earlier than the engine restart in response to fulfillment of the notification restart condition, contrary to the early ON fixation and the ON fixation. In this case, the engine restart based on the synchronous restart function may be performed, or may not be performed, and therefore, the driver may feel strange or uncomfortable.

In the control system as described above, in the mode (1), the electronic control unit, when performing the synchronous restart function, may be configured to (i) restart the engine when the notification output by the notifying function is set to ON, and (ii) detect the notification fixation, when the notification output by the notifying function is OFF even when the intervehicular distance between the own vehicle that is stopped and the preceding vehicle becomes equal to or larger than a second predetermined distance that is larger than the first predetermined distance.

With the configuration of the control system as described above, when the notification output by the notifying function is OFF even when the intervehicular distance between the own vehicle that is stopped and the preceding vehicle becomes equal to or larger than the second predetermined distance (>the first predetermined distance), the notification fixation (OFF fixation) is detected, whereby the synchronous restart function is restricted. As a result, the engine is inhibited from restarting until the normal restart condition is fulfilled, in other words, the timing of restarting of the engine is made uniform (for example, is set to the time of brake OFF), so that the driver is less likely or unlikely to feel strange or uncomfortable.

On the other hand, in the control system as described above, in the mode (2), the electronic control unit, when performing the synchronous restart function, may be configured to (i) restart the engine when the intervehicular distance between the own vehicle that is stopped and the preceding vehicle becomes equal to or larger than the first predetermined distance, and (ii) detect the notification fixation, when the notification output by the notifying function is OFF even when the intervehicular distance between the own vehicle that is stopped and the preceding vehicle becomes equal to or larger than a second predetermined distance that is larger than the first predetermined distance.

With the configuration of the control system as described above, the notification output is set to ON according to the notifying function, when the intervehicular distance between the own vehicle that is stopped and the preceding vehicle becomes equal to or larger than the first predetermined distance. Apart from this arrangement, the engine is restarted according to the synchronous restart function, when the intervehicular distance between the own vehicle that is stopped and the preceding vehicle becomes equal to or larger than the first predetermined distance. With these arrangements, it is possible to restart the engine in synchronization with notification by the notifying function, even if the normal restart condition is not fulfilled, while controlling engine restart by the automatic stop and restart function, and notification by the notifying function, independently of each other.

Also, with the configuration of the control system as described above, unlike the mode (1), ON (generation) of the notification output does not provide a condition under which the engine is restarted; therefore, even in the case where notification by the notifying function is more or less delayed, the engine is restarted, when the intervehicular distance between the own vehicle that is stopped and the preceding vehicle becomes equal to or larger than the first predetermined distance. Thus, starting assistance can be performed in appropriate timing.

If the engine is restarted based on the synchronous restart function when the intervehicular distance from the preceding vehicle becomes equal to or larger than the first predetermined distance, in the case (delayed ON fixation) where ON (generation) of the notification output is delayed too much, or in the case (OFF fixation) where the notification output is not set to ON, the driver may feel strange or uncomfortable since the engine is automatically started without any notification.

In this respect, according to the disclosure, when the notification output of the notifying function is OFF even when the intervehicular distance between the own vehicle that is stopped and the preceding vehicle becomes equal to or larger than the second predetermined distance (>the first predetermined distance), the notification fixation (OFF fixation) is detected. As a result, the synchronous restart function is restricted, and the engine is inhibited from restarting until the normal restart condition is fulfilled, even after the intervehicular distance between the own vehicle that is stopped and the preceding vehicle becomes equal to or larger than the first predetermined distance. Therefore, the driver is less likely or unlikely to feel strange or uncomfortable because of automatic restart of the engine without notification.

In this connection, if a malfunction arises in a measurement system for measuring the intervehicular distance between the own vehicle and the preceding vehicle, it may be difficult to detect notification fixation.

In view of the above situation, in the control system of the vehicle as described above, the electronic control unit may be configured to (i) set a flag when the notification fixation is detected, and (ii) set the flag, when a traveling distance of the own vehicle after restart of the engine becomes equal to or larger than a third predetermined distance, in a condition where the notification output by the notifying function is OFF.

With the configuration of the control system as described above, when it is difficult to detect notification fixation, based on the first and second predetermined distances, the notification fixation can be detected without fail, based on the traveling distance of the own vehicle.

In the control system as described above, in the mode (2), the electronic control unit, when performing the synchronous restart function, may be configured to (i) restart the engine, when the intervehicular distance between the own vehicle that is stopped and the preceding vehicle becomes equal to or larger than the first predetermined distance, and (ii) restart the engine that is automatically stopped, even though the predetermined restart condition is not fulfilled, when the notification output is kept in the OFF state even when the intervehicular distance between the own vehicle that is stopped and the preceding vehicle becomes equal to the first predetermined distance, and the notification output is set to ON when the intervehicular distance between the own vehicle and the preceding vehicle is smaller than a second predetermined distance that is larger than the first predetermined distance.

If it is deemed more important to reduce the strange feeling or uncomfortableness that would be caused by engine restart without notification, it may be considered to detect OFF fixation of the notifying function, when the notification output is OFF even after the intervehicular distance between the own vehicle that is stopped and the preceding vehicle becomes equal to or larger than the first predetermined distance, for example. In this case, however, a sufficient engine automatic stop period is ensured; therefore, if the delay in notification based on the notifying function is within a permissible range, it may be preferable to restart the engine in accordance with starting of the preceding vehicle, rather than inhibiting restart of the engine until the predetermined restart condition is fulfilled. Nonetheless, if the engine is restarted when the intervehicular distance between the own vehicle that is stopped and the preceding vehicle becomes equal to the first predetermined distance, the driver may feel strange or uncomfortable, depending on the degree of delay in notification based on the notifying function.

In this respect, with the configuration of the control system as described above, when the notification output remains OFF even after the intervehicular distance between the own vehicle that is stopped and the preceding vehicle becomes equal to the first predetermined distance, and the notification output is set to ON when the intervehicular distance from the preceding vehicle is smaller than the second predetermined distance (>the first predetermined distance), the engine is restarted even if the normal restart condition is not fulfilled. Thus, it is possible to perform starting assistance in appropriate timing, while preventing the driver from feeling strange or uncomfortable.

With the control system of the vehicle and its control method according to the disclosure as described above, it is possible to perform starting assistance in appropriate timing, and reduce instability with which the engine is restarted.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a view showing a principal part of a vehicle according to a first embodiment as one example of the disclosure;

FIG. 2 is a block diagram schematically showing a control system shown in FIG. 1;

FIG. 3 is a view schematically illustrating a condition where a notifying function provided in the control system is activated;

FIG. 4 is a time chart schematically showing one example of automatic stop and restart control at normal times, in the control system;

FIG. 5 is a time chart schematically showing one example of automatic stop and restart control at the time of early ON fixation, in the control system;

FIG. 6 is a time chart schematically showing one example of automatic stop and restart control at the time of ON fixation, in the control system;

FIG. 7 is a time chart schematically showing one example of automatic stop and restart control at the time of OFF fixation, in the control system;

FIG. 8 is a flowchart schematically showing one example of automatic stop and restart control, in the control system;

FIG. 9 is a flowchart schematically showing one example of a preceding vehicle start notification output routine, in the control system;

FIG. 10 is a flowchart schematically showing one example of a notification fixation routine, in the control system;

FIG. 11 is a time chart schematically showing one example of automatic stop and restart control according to a modified example of the first embodiment;

FIG. 12 is a time chart schematically showing one example of automatic stop and restart control according to a second embodiment of the disclosure;

FIG. 13 is a time chart schematically showing one example of automatic stop and restart control at the time of notification fixation, in the control system;

FIG. 14 is a time chart schematically showing one example of automatic stop and restart control at the time of notification fixation, in the control system; and

FIG. 15 is a time chart schematically showing one example of automatic stop and restart control at the time of notification fixation, in the control system.

### DETAILED DESCRIPTION OF EMBODIMENTS

Some embodiments of the disclosure will be described based on the drawings.

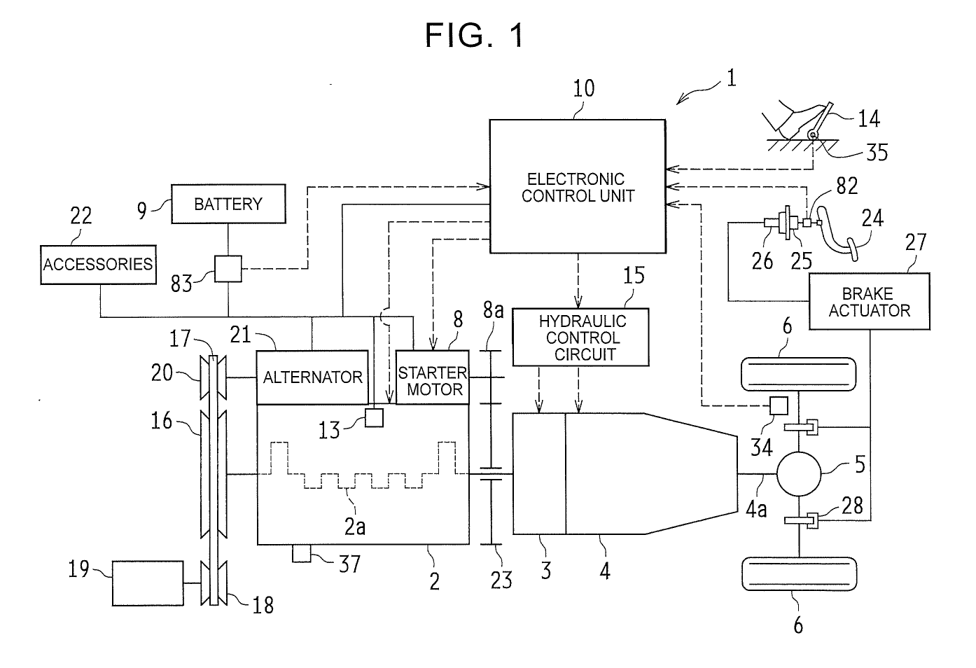

A first embodiment will be described. Initially, the overall configuration of the first embodiment will be described. FIG. 1 shows a principal part of a vehicle 1 according to the first embodiment. As shown in FIG. 1, the vehicle 1 includes an engine 2, a torque converter 3 as a fluid coupling, an automatic transmission 4, a starter motor 8 that starts the engine 2, a battery 9 that supplies electric power to electronic components, such as the starter motor 8 and ignitors 13, and an electronic control unit 10 included in a control system.

In the vehicle 1, driving force (torque) generated from a crankshaft 2a of the engine 2 as a drive source is transmitted to the automatic transmission 4 via the torque converter 3, and is delivered from an output shaft 4a after the speed of rotation is changed at an appropriate speed ratio in the automatic transmission 4, so as to be finally transmitted to right and left drive wheels 6, 6, via a differential gear unit 5. The electronic control unit 10 performs control of the engine 2 and shift control of the automatic transmission 4, for example, and also performs automatic stop and restart control for automatically stopping the engine 2 when predetermined automatic stop conditions are fulfilled, and restarting the engine 2 when predetermined restart conditions are fulfilled during automatic stop of the engine 2. Namely, the vehicle 1 of the first embodiment has an automatic stop and restart function, namely, has both an automatic stop function (which will also be called “idle-stop function”) of automatically stopping the engine 2, and an automatic restart function of automatically restarting the engine 2 that was automatically stopped.

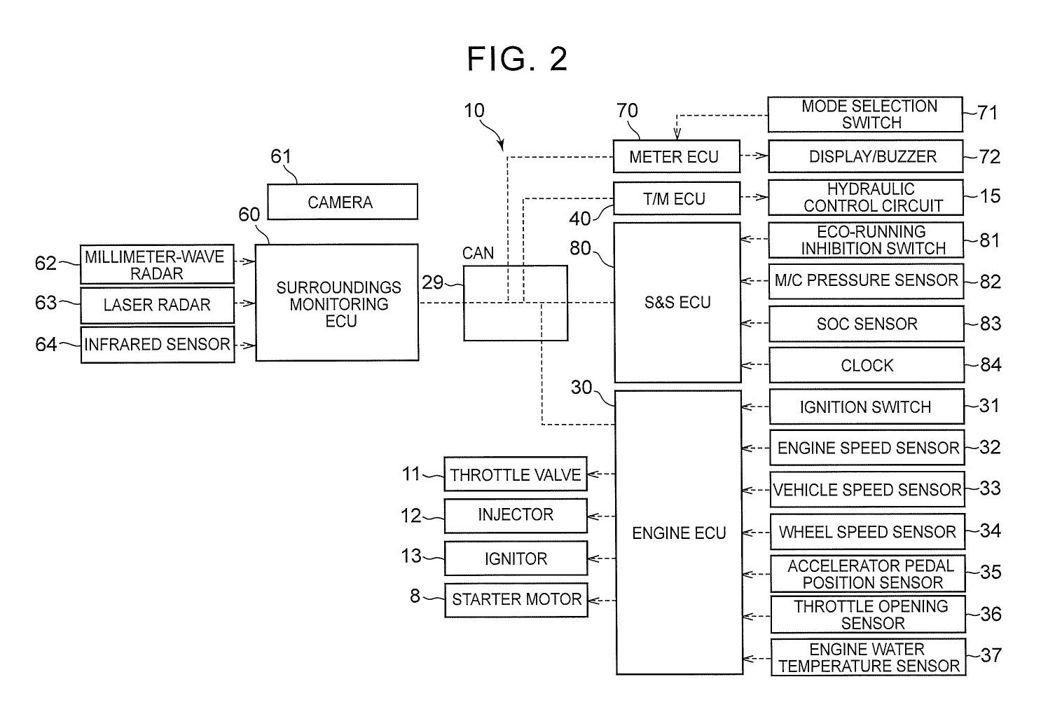

The engine 2 is configured as a gasoline engine having an electronically controlled throttle valve 11 (see FIG. 2), injectors 12 (see FIG. 2), ignitors 13, and so forth. The throttle valve 11 is used for control of the intake air amount, and the injector 12 is used for control of the amount and timing of fuel supply, while the ignitor 13 is used for control of the ignition timing. The throttle valve 11, injectors 12, and the ignitors 13 are basically controlled by the electronic control unit 10, according to the amount of operation of an accelerator pedal 14 by the driver.

The torque converter 3 includes a pump impeller (not shown) coupled to the crankshaft 2a, a turbine wheel (not shown) coupled to the automatic transmission 4, a stator (not shown) having a torque amplifying function, and a lock-up clutch (not shown) for directly coupling the engine 2 with the automatic transmission 4. The pump impeller and the turbine wheel are arranged to transmit driving force via fluid. However, when the vehicle travels at a high speed, for example, the lock-up clutch directly couples the pump impeller with the turbine wheel, so as to increase the transmission efficiency with which the driving force is transmitted from the engine 2 to the automatic transmission 4.

The automatic transmission 4 is configured as a multi-speed transmission of a planetary gear type having a plurality of gear positions having different gear ratios, which are established by selectively placing two or more clutches and brakes in engaged or released states. More specifically, the two or more clutches and brakes are selectively engaged or released, according to hydraulic pressures supplied from a hydraulic control circuit 15, so that the automatic transmission 4 is placed in one of two or more forward-drive gear positions and a reverse-drive gear position, according to the engaged/released states of the clutches and brakes.

Apart from the driving force transmission system from the engine 2 to the drive wheels 6, 6 as described above, driving force generated from the engine 2 is transmitted to a belt 17 via a pulley 16 connected to the crankshaft 2a, and a pulley 18 coupled to a compressor 19 and a pulley 20 coupled to an alternator 21 are rotated with the driving force transmitted to the belt 17. Namely, as the crankshaft 2a rotates, the compressor 19 for use in air conditioning, and the alternator 21 for use in power generation are driven with the driving force generated from the engine 2.

The alternator 21 is configured to operate with the driving force of the engine 2, so that it can generate electric power. The electric power generated by the alternator 21 is supplied to, for example, the starter motor 8, ignitors 13, accessories 22 (electronic components in general), etc. The electric power generated by the alternator 21 is also converted by a rectifier (not shown) into DC power, with which the battery 9 is charged.

With electric power supplied from the battery 9 to the starter motor 8, a pinion gear 8a provided on an output shaft of the starter motor 8 rotates, and the pinion gear 8a engages with a ring gear provided at the periphery of a flywheel 23, so that the starter motor 8 starts the engine 2. The starter motor 8 performs cranking of the engine 2, at the time of engine restart after automatic stop of the engine under the automatic stop and restart control, as well as the time of cold start and the time of engine start following the driver's operation on the ignition key.

The battery 9 is provided by a secondary battery, such as a lithium-ion battery, nickel hydride battery or a lead storage battery, or a capacitor, for example. From the battery 9, electric power is supplied to meters, electronic control unit 10, and the accessories 22, as well as the starter motor 8 and the ignitors 13.

In the vehicle 1, braking force is applied to the drive wheels 6, 6, according to operation of the brake pedal 24. More specifically, the operating force applied to the brake pedal 24 is amplified by a brake booster 25, according to the amount of depression of the brake pedal 24, and the operating force thus amplified is converted by a master cylinder 26 into hydraulic pressure that generates braking force of the vehicle 1. The hydraulic pressure from the master cylinder 26 is controlled by a brake actuator 27, and then transmitted to a wheel cylinder 28 as a hydraulic braking unit provided in each drive wheel 6, so that braking force is applied to each drive wheel 6.

Next, the control system of the first embodiment will be described. FIG. 2 is a block diagram schematically showing the electronic control unit 10. The electronic control unit 10 of the first embodiment includes an engine ECU 30, T/M ECU 40, surroundings monitoring ECU 60, meter ECU 70, and an S&S ECU 80. Each ECU (Electronic Control Unit) includes a so-called microcomputer having CPU (Central Processing Unit), ROM (Read Only Memory) in which programs executed by the CPU, maps, etc. are stored in advance, RAM (Random Access Memory) into which the CPU temporarily stores data as needed, back-up RAM that holds data even while power is disconnected, input/output interface, and so forth. The CPU performs various controls, by performing signal processing according to the programs stored in advance in the ROM, while utilizing the temporary storage function of the RAM. The engine ECU 30, T/M ECU 40, surroundings monitoring ECU 60, meter ECU 70, and the S&S ECU 80 are connected via a CAN (Controller Area Network) 29, such that information can be exchanged among the ECUs.

Next, the engine ECU 30 will be described. The engine ECU 30 receives, for example, a signal indicating the position of an ignition switch 31 set to a start position through operation of an ignition key (not shown), a signal indicating the engine speed detected by an engine speed sensor 32, a signal indicating the rotational speed of the output shaft 4a of the automatic transmission 4 corresponding to the vehicle speed V detected by a vehicle speed sensor 33, signals indicating the rotational speeds of the drive wheels 6, 6 detected by wheel speed sensors 34, a signal indicating the accelerator pedal stroke detected by an accelerator pedal position sensor 35, a signal indicating the opening of the throttle valve 11 detected by a throttle opening sensor 36, a signal indicating the temperature (engine water temperature) of engine coolant detected by an engine water temperature sensor 37, and so forth.

On the other hand, the engine ECU 30 outputs engine output control signals for output control of the engine 2, and a drive control signal to the starter motor 8, for example, based on the input signals from the above-indicated various sensors. The engine output control command signals include a throttle signal for controlling opening/closing of the throttle valve 11, a signal for controlling the injection amount and injection timing of fuel injected from the injectors 12, and a signal for controlling the ignition timing of ignition plugs (not shown) by the ignitors 13. Through these signals, the engine ECU 30 performs output control of the engine 2, drive control of the starter motor 8, and so forth.

Next, the T/M ECU 40 will be described. The T/MECU 40 performs shift control of the automatic transmission 4, by generating a hydraulic control command signal for control of the hydraulic control circuit 15 associated with shifting of the automatic transmission 4.

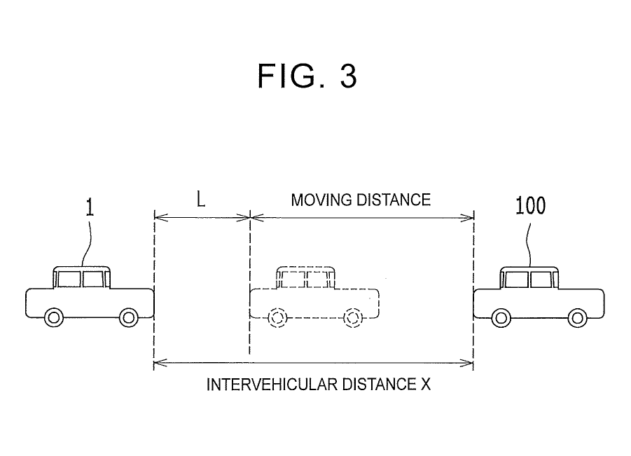

Next, the surroundings monitoring ECU 60 will be described. The surroundings monitoring ECU 60 receives image data from a camera 61 that captures images of the surroundings of the vehicle 1, detection signals from a millimeter-wave radar 62 that uses radio waves that can be used even in a fog or when it is raining, a laser radar 63 that measures the distance and direction of an object from reflected light, and an infrared sensor 64 that receives infrared light and retrieves necessary information, and so forth. The surroundings monitoring ECU 60 is configured to determine whether there is a preceding vehicle 100 (see FIG. 3), and whether the preceding vehicle 100 has started, for example, and measure the distance between the own vehicle 1 and the preceding vehicle 100, based on the input signals from the above devices, for example. Then, the surroundings monitoring ECU 60 outputs the determination results and measurement results to the meter ECU 70 and the S&S ECU 80.

Next, the meter ECU 70 will be described. The meter ECU 70 receives an ON/OFF signal of a mode selection switch 71 provided on an instrument panel (not shown), for example, which is operated by the driver. In the case where a preceding vehicle start notification mode is selected (where the mode selection switch 71 is ON), the meter ECU 70 notifies the driver, via a display/buzzer 72, that the preceding vehicle 100 has started, when it receives, from the surroundings monitoring ECU 60, the determination result to the effect that the preceding vehicle 100 has started during stop of the own vehicle 1, and the intervehicular distance X between the own vehicle 1 and the preceding vehicle 100 becomes equal to or larger than a first predetermine distance A, as shown in FIG. 3. Namely, the vehicle 1 of the first embodiment has a notifying function of notifying the driver that the preceding vehicle 100 has started, by setting a preceding vehicle start notification output to ON when the intervehicular distance X between the own vehicle 1 and the preceding vehicle 100 becomes equal to or larger than the first predetermined distance A during stop of the own vehicle 1. Here, the first predetermined distance A may be set by the driver, or may be a predetermined value (preset value). In the case where the preceding vehicle start notification mode is not selected (where the mode selection switch 71 is OFF), the meter ECU 70 is configured not to notify the driver of starting of the preceding vehicle 100, even if the preceding vehicle 100 starts.

Next, the S&S ECU 80 will be described. The S&S (Stop and Start) ECU 80 receives an ON/OFF signal from an eco-running inhibition switch 81, which indicates whether the driver inhibits execution of the automatic stop and restart control, a signal indicating a brake master cylinder pressure of the master cylinder 26 from an MIC pressure sensor 82 that detects the brake master cylinder pressure generated according to the force on the brake pedal 24, and a signal indicating ON/OFF of the brake based on the detection result. The S&S ECU 80 also receives a signal indicating the amount of charge (which will also be called “SOC (State Of Charge)”) of the battery 9 detected by an SOC sensor 83, and various time signals measured by a clock 84.

When the S&S ECU 80 determines, based on the input signals from these various sensors and other ECUs, that automatic stop conditions are fulfilled, the S&S ECU 80 transmits an engine stop command to the engine ECU 30, so as to execute fuel cut control for stopping supply of the fuel to combustion chambers of the engine 2. On the other hand, when the S&S ECU 80 determines that restart conditions are fulfilled during automatic stop of the engine, it transmits an engine restart command to the engine ECU 30, so as to start supply of the fuel to the combustion chambers of the engine 2, and cause the starter motor 8 to restart the engine 2.

The predetermined automatic stop conditions include, for example, conditions that (1) the eco-running inhibition switch 81 is OFF, (2) the accelerator pedal 14 is not depressed (which is detected by the accelerator pedal position sensor 35), (3) the brake is ON (which is detected by the M/C pressure sensor 82), (4) the vehicle 1 is stopped (the vehicle speed V is equal to 0 km/h) (which is detected by the wheel speed sensors 34), (5) the SOC detected by the SOC sensor 83 is equal to or larger than a predetermined charge amount, (6) the engine water temperature detected by the engine water temperature sensor 37 is equal to or higher than a predetermined water temperature, and so forth. The S&S ECU 80 determines that the automatic stop conditions are fulfilled, when all of these conditions (1) through (6) are satisfied.

In the meantime, the restart conditions include conditions that (7) the brake pedal 24 is not depressed, (8) the SOC falls below the predetermined charge amount, and (9) the engine water temperature falls below the predetermined water temperature, for example. The S&S ECU 80 determines that the restart conditions are fulfilled, when one or more of these conditions (7) to (9) are satisfied during automatic stop of the engine.

Also, in the first embodiment, the S&S ECU 80 is configured to restart the engine 2, when the meter ECU 70 notifies the driver, via the display/buzzer 72, that the preceding vehicle 100 has started (i.e., when the preceding vehicle start notification output is ON).

Namely, in the first embodiment, apart from the predetermined restart conditions, a condition that the preceding vehicle start notification output is set to ON is provided as another condition for restarting the engine 2. Therefore, the automatic stop and restart function of the first embodiment includes a function (synchronous restart function) of restarting the engine 2 that is automatically stopped, in synchronization with notification by the notifying function, even if the predetermined restart conditions are not fulfilled. Accordingly, after the vehicle 1 is stopped and the engine 2 is automatically stopped, the engine 2 is arranged to be restarted at the earlier opportunity, in either of the case (a) where the foot is released from the brake pedal 24, for example, and the restart conditions are fulfilled, and the case (b) where the intervehicular distance X between the own vehicle 1 and the preceding vehicle 100 becomes equal to or larger than the first predetermined distance A, and the preceding vehicle start notification output of the meter ECU 70 is set to ON. In this connection, the above conditions (7) to (9) will also be referred to as “normal restart conditions”, and the condition that the preceding vehicle start notification output of the meter ECU 70 is set to ON may also be referred to as “notification restart condition”, for the sake of convenience in explanation.

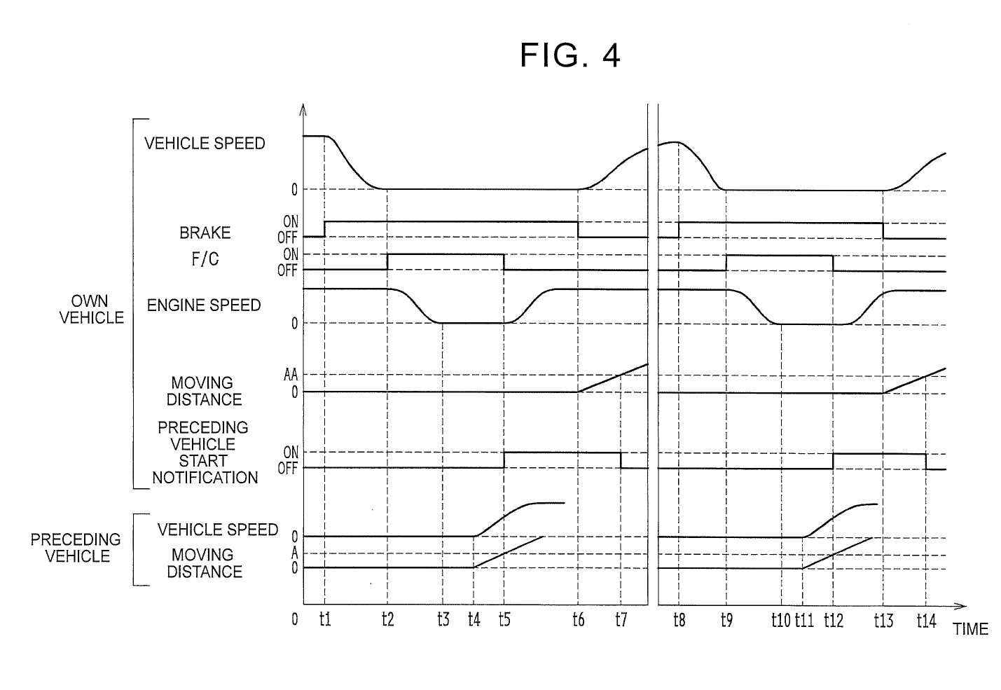

Next, automatic stop and restart control performed by the electronic control unit 10 at the time of occurrence of notification fixation will be described. FIG. 4 is a time chart schematically showing one example of automatic start and restart control at normal times. In the example of FIG. 4, automatic stop conditions other than the conditions that vehicle speed V is equal to 0 and the brake is ON, and restart conditions other than the condition that the brake is OFF, are supposed to be fulfilled. In FIG. 4, the engine speed is indicated, without taking account of a time lag between fulfillment of the automatic stop conditions and ON (execution) of the F/C (fuel cut), and a time lag between fulfillment of the restart conditions and OFF (termination) of the F/C.

As shown in FIG. 3, the intervehicular distance X between the own vehicle 1 and the preceding vehicle 100 is strictly the sum of the intervehicular distance L measured when these vehicles 1, 100 are stopped, and the moving distance of the preceding vehicle 100 after it starts moving. However, in FIG. 4, the moving distance A of the preceding vehicle 100 means that the intervehicular distance X is equal to A (X=A), for the sake of convenience in explanation.

When the brake is set to ON (i.e., the brake is applied) through the driver's operation to depress the brake pedal 24, at time t1 (t8), the vehicle speed V starts decreasing. When the vehicle speed V becomes equal to zero at time t2 (t9), the automatic stop conditions are fulfilled, and the F/C is set to ON (i.e., is initiated), so that the engine speed starts decreasing. Then, at time t3 (t10), the engine speed becomes equal to zero.

When the intervehicular distance X between the preceding vehicle 100 that started at time t4 (t11), and the own vehicle 1 that is stopped, becomes equal to a first predetermined distance A at time t5 (t12), the preceding vehicle start notification output is set to ON. As a result, the notification restart condition is satisfied, so that the F/C is set to OFF (i.e., is finished), and the engine speed starts increasing.

When the driver releases his/her foot from the brake pedal 24, so that the brake is set to OFF (i.e., the brake is released), at time t6 (t13), the vehicle 1 starts. Then, when the traveling distance Y (moving distance) of the vehicle 1 after engine restart becomes equal to a third predetermined distance AA, at time t7 (t14), the preceding vehicle start notification output is set to OFF.

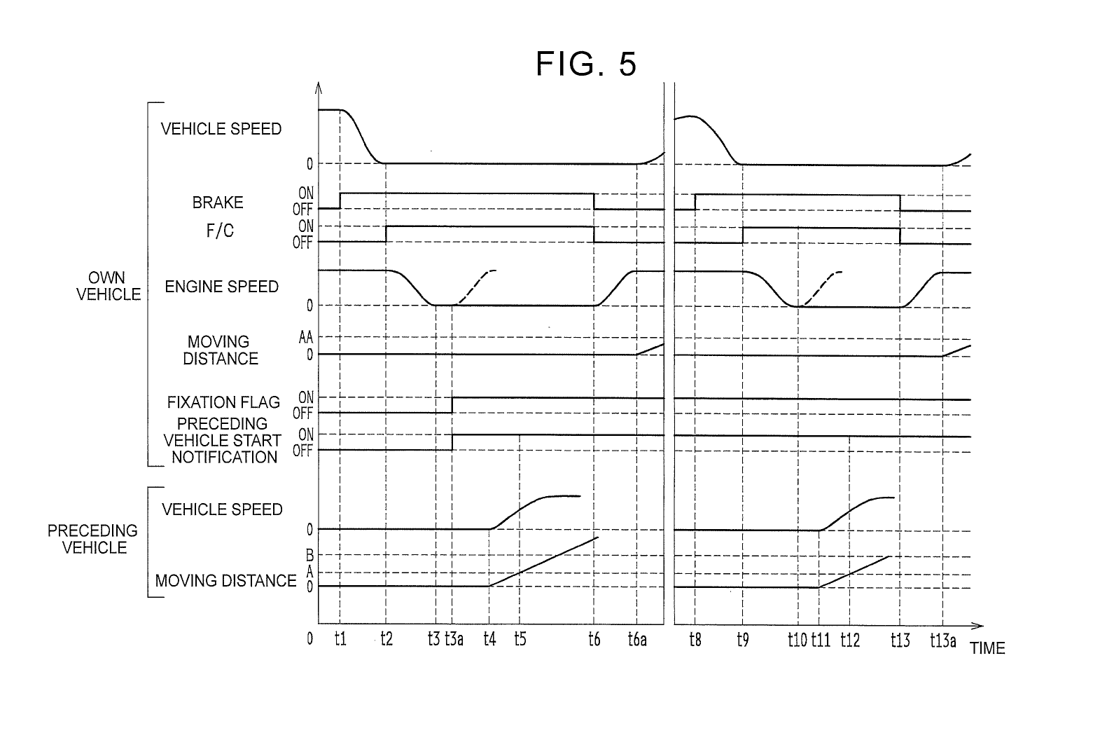

In the time charts of FIG. 5 to FIG. 7 and FIG. 11 to FIG. 15 which will be described later, too, the brake is set to ON at time t1 and time t8, the vehicle speed V becomes equal to zero at time t2 and time t9, so that the automatic stop conditions are fulfilled, the engine speed becomes equal to zero at time t3 and time t10, the preceding vehicle 100 starts at time t4 and time t11, the intervehicular distance X between the own vehicle 1 that is stopped and the preceding vehicle 100 becomes equal to the first predetermined distance A at time t5 and time t12, the brake is set to OFF at time t6 and time t13, and the traveling distance Y of the own vehicle 1 after engine restart becomes equal to the third predetermined distance AA at time t7 and time t14, as in the time chart of FIG. 4. To avoid repetition, description of operation at each point in time will be omitted as needed. In the time charts of FIG. 5 to FIG. 7 and FIG. 11 to FIG. 15, too, automatic stop conditions other than the conditions that the vehicle speed V is equal to 0 and the brake is ON are supposed to be fulfilled, and restart conditions other than the condition that the brake is OFF are supposed to be fulfilled. Further, in FIG. 5 to FIG. 7 and FIG. 11 to FIG. 15, the engine speed is indicated, without taking account of a time lag between fulfillment of the automatic stop conditions and ON (initiation) of the F/C (fuel cut), and a time lag between fulfillment of the restart conditions and OFF (finish) of the F/C. Also, in FIG. 5 to FIG. 7 and FIG. 11 to FIG. 15, too, the moving distance A of the preceding vehicle 100 means that the intervehicular distance X is equal to A (X=A), and the moving distance B of the preceding vehicle 100 means that the intervehicular distance X is equal to B (X=B), for the sake of convenience in explanation.

Thus, in the first embodiment, the engine 2 is restarted when the intervehicular distance X from the preceding vehicle 100 becomes equal to or larger than the first predetermined distance A, and the preceding vehicle start notification output is set to ON, in other words, when the notification restart condition is fulfilled even though the normal restart conditions are not fulfilled. Therefore, even when the driver is not aware that the preceding vehicle 100 started during stop of the own vehicle 1, it is possible to reduce a delay in start-up at the time of engine restart, and cause the driver to be aware of starting of the preceding vehicle 100. Thus, starting assistance can be performed in appropriate timing.

In some cases, however, the notifying function may not be normally activated, due to a malfunction of a notification system, such as the display/buzzer 72, for example. More specifically, there may arise ON fixation representing a condition where the preceding vehicle start notification output is kept in the ON state, early ON fixation representing a condition where the preceding vehicle start notification output is set to ON before the intervehicular distance X becomes equal to or larger than the first predetermined distance A, delayed ON fixation representing a condition where the preceding vehicle start notification output is set to ON with a delay from the time when the intervehicular distance X becomes equal to or larger than the first predetermined distance A, and OFF fixation representing a condition where the preceding vehicle start notification output is kept in the OFF state. The early ON fixation, ON fixation, delayed ON fixation, and OFF fixation will be collectively called “notification fixation”.

For example, when the early ON fixation occurs after automatic stop of the engine, the preceding vehicle start notification output is set to ON before the intervehicular distance X becomes equal to or larger than the first predetermined distance A, or before the normal restart conditions are satisfied. Therefore, a sufficient engine automatic stop period cannot be provided, and it may become difficult to ensure an opportunity of improvement of fuel efficiency.

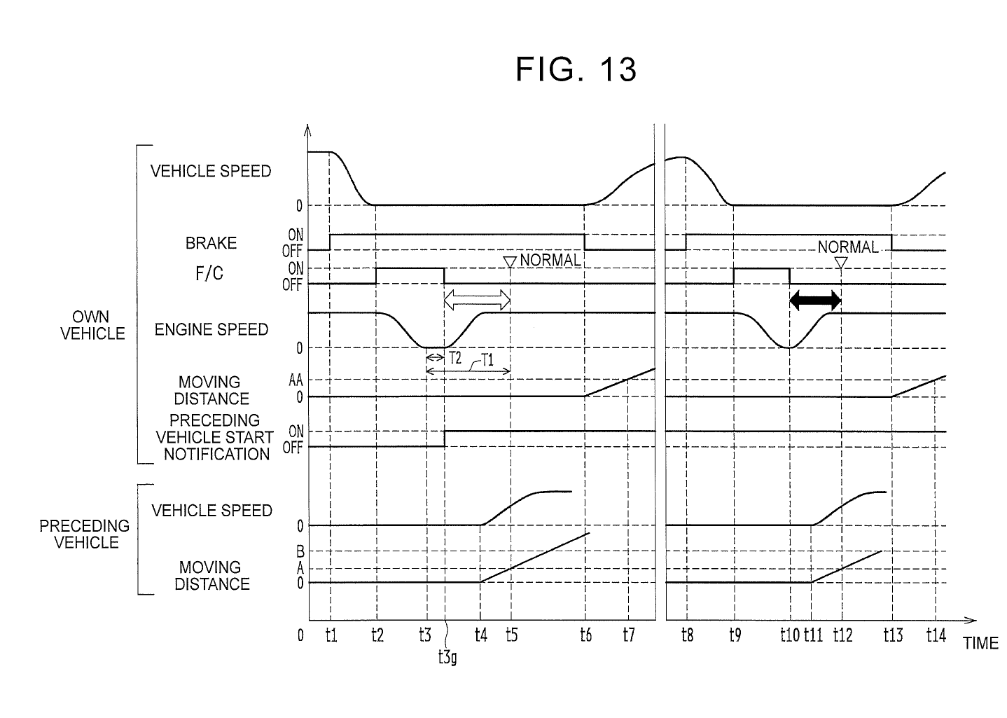

FIG. 13 is a time chart schematically showing one example of automatic stop and restart control at the time of notification fixation. Normally, the preceding vehicle start notification output is supposed to be ON, at time t5 when the intervehicular distance X between the own vehicle 1 that is stopped and the preceding vehicle 100 becomes equal to the first predetermined distance A. However, if the early ON fixation occurs, and the preceding vehicle start notification output is set to ON at time t3g (t3<t3g<t4), the notification restart condition is fulfilled, and the engine speed starts increasing.

Thus, if the early ON fixation occurs after automatic stop of the engine, the engine 2 is restarted earlier than normal (time t5), by an amount indicated by the blank arrow in FIG. 13. As a result, the engine automatic stop period, which was originally equal to T1, is shortened to T2, and it becomes difficult to ensure the opportunity of improvement of fuel efficiency. Further, when the driver intends to release his/her foot from the brake pedal 24 once the preceding vehicle 100 starts, the driver may feel awkward or bothered if the early ON fixation occurs.

When the ON fixation occurs before automatic stop of the engine, the engine 2 is restarted, immediately after the vehicle 1 stops and the engine 2 automatically stops, since the preceding vehicle start notification output is ON. Therefore, the fuel efficiency may deteriorate due to the brief automatic stop of the engine.

For example, when the preceding vehicle start notification output is kept in the ON state even after the traveling distance Y of the own vehicle 1 after engine restart becomes equal to a third predetermined distance AA at time t7 in FIG. 13, the ON fixation is expected to occur before the next automatic stop of the engine. Normally, the preceding vehicle start notification output is supposed to be ON, at time t12 when the intervehicular distance X between the own vehicle 1 that is stopped and the preceding vehicle 100 becomes equal to the first predetermined distance A. However, if the ON fixation occurs, the preceding vehicle start notification output is already ON before the engine 2 automatically stops; therefore, the engine 2 is restarted, at the same time that the engine 2 automatically stops at time t10. Thus, if the ON fixation occurs before the engine 2 automatically stops, the engine 2 is restarted earlier than normal (time t12) by an amount corresponding to the black arrow in FIG. 13, and the fuel efficiency may deteriorate due to the brief engine automatic stop.

On the other hand, there may arise delayed ON fixation where the preceding vehicle start notification output is set to ON with a delay from the time when the intervehicular distance X becomes equal to or larger than the first predetermined distance A, or OFF fixation where the preceding vehicle start notification output is kept in the OFF state, contrary to the early ON fixation and the ON fixation.

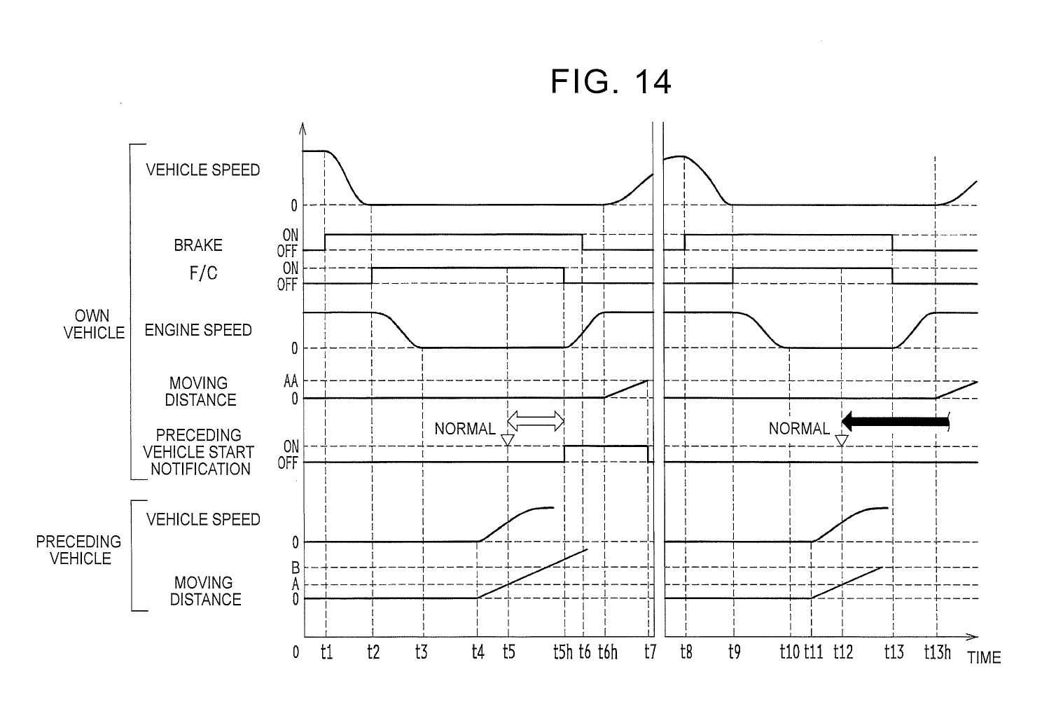

FIG. 14 is a time chart schematically showing one example of automatic stop and restart control at the time of notification fixation. Normally, the preceding vehicle start notification output is supposed to be ON, at time t5 when the intervehicular distance X between the own vehicle 1 that is stopped and the preceding vehicle 100 becomes equal to the first predetermined distance A. However, in some cases, the delayed ON fixation may occur, and the preceding vehicle start notification output may not be set to ON until time t5h (t5<t5h<t6). In this case, restart of the engine is delayed from normal (time t5), by an amount corresponding to the blank arrow in FIG. 14, and then, the own vehicle 1 starts at time t6h (t6<t6h<t7). Also, if the OFF fixation occurs, the preceding vehicle start notification output continues to fail to be ON (i.e., continues to be OFF), as indicated by the black arrow in FIG. 14, and the engine 2 is not restarted, until the driver notices starting of the preceding vehicle 100, and releases the brake (brake OFF) at time t13, for example. Then, at time t13h (t13<t13h), the own vehicle 1 is started. Thus, if the delayed ON fixation or OFF fixation occurs, the engine restart based on the synchronous restart function may be performed with delay, or may not be performed, and the driver may feel strange or uncomfortable.

In the first embodiment, when notification fixation is detected, namely, when the preceding vehicle start notification output is placed in the ON state or OFF state in a situation other than a predetermined situation, the function (synchronous restart function) of restarting the engine 2 when the preceding vehicle start notification output is set to ON is restricted, and the engine 2 is inhibited from restarting until the normal restart conditions are fulfilled, so as to deal with the events as described above.

In this connection, the cases where “the preceding vehicle start notification output is placed in the ON state or OFF state in a situation other than a predetermined situation” include a case (I) where the preceding vehicle start notification output is placed in the ON state in a situation where the intervehicular distance X is smaller than the first predetermined distance A, as one example of the early ON fixation, a case (II) where the preceding vehicle start notification output is kept in the ON state even though the traveling distance Y is equal to or larger than the third predetermined distance AA, as one example of the ON fixation, and a case (III) where the preceding vehicle start notification output is in the OFF state in a situation where the intervehicular distance X is equal to or larger than a second predetermined distance B (>A), as one example of the delayed ON fixation and the OFF fixation.

Then, the electronic control unit 10 is configured to detect early ON fixation (notification fixation), in the case (I) where the preceding vehicle start notification output is set to ON, even though the intervehicular distance X between the own vehicle 1 that is stopped and the preceding vehicle 100 is smaller than the first predetermined distance A.

Here, it may be considered that the measured intervehicular distance X is wrong. However, the possibility that the measured vehicular distance X is wrong is low, because mutual monitoring is performed in the surroundings monitoring ECU 60, based on two or more measurement values from the camera 61, millimeter-wave radar 62, laser radar 63, infrared sensor 64, and so forth. The inconsistency between the intervehicular distance X and the notification is highly likely to be caused by a malfunction of the notification system, such as the display/buzzer 72. Therefore, for example, the surroundings monitoring ECU 60 is configured to send an error flag to the S&S ECU 80, when the meter ECU 70 notifies the driver via the display/buzzer 72 that the preceding vehicle 100 has started (i.e., the preceding vehicle start notification output is set to ON), even though the intervehicular distance X measured by the millimeter-wave radar 62, etc., is smaller than the first predetermined distance A.

When the S&S ECU 80 receives the error flag, it determines detection of the early ON fixation, and sets a notification fixation flag F to ON. While the notification fixation flag F is ON, the S&S ECU 80 restricts the synchronous restart function of restarting the engine 2 when the preceding vehicle start notification output is set to ON, and inhibits the engine 2 from restarting until the normal restart conditions are fulfilled. When the notification fixation flag F is set to ON, a warning lamp (not shown) provided on the instrument panel, for example, may be turned on or flickered.

FIG. 5 is a time chart schematically showing one example of automatic stop and restart control at the time of early ON fixation. As shown in FIG. 5, if the preceding vehicle start notification output is set to ON at time t3a (t3<t3a<t4), after the engine 2 automatically stops at time t3, and before the intervehicular distance X becomes equal to the first predetermined distance A at time t5, the notification fixation flag F is set to ON. When the notification fixation flag F is ON, the synchronous restart function is restricted, and therefore, engine restart as indicated by a thick broken line at time t3a does not take place. As a result, the engine automatic stop period is prevented from being shortened, and the opportunity of improvement of fuel efficiency is ensured.

Then, if the brake is set to OFF (i.e., is released) at time t6, and the normal restart conditions are fulfilled, the engine 2 is restarted, and the vehicle 1 starts at time t6a (>t6) at which the engine speed reaches the idle speed, for example. Since the synchronous restart function is restricted while the notification fixation flag F is ON, the engine 2 would not be restarted at the same time that the engine automatically stops, as indicated by a thick broken line at time t10. Thus, the fuel efficiency is less likely or unlikely to deteriorate due to the brief engine automatic stop. Then, if the brake is set to OFF at time t13, and the normal restart conditions are fulfilled, the engine 2 restarts, and the vehicle 1 starts at time t13a (>t13).

Also, the electronic control unit 10 is configured to detect ON fixation (notification fixation), in the case (II) where the preceding vehicle start notification output is kept in the ON state, even when the traveling distance Y of the own vehicle 1 after engine restart becomes equal to or larger than the third predetermined distance AA.

For example, the S&S ECU 80 can measure the traveling distance Y of the own vehicle 1 after engine restart, based on the detection results from the wheel speed sensors 34, etc. Then, when the preceding vehicle start notification output is kept in the ON state even when the traveling distance Y becomes equal to or larger than the third predetermined distance AA, the S&S ECU 80 determines that the ON fixation is detected, and sets the notification fixation flag F to ON. While the notification fixation flag F is ON, the S&S ECU 80 restricts the synchronous restart function, and inhibits the engine 2 from restarting until the normal restart conditions are fulfilled. Thus, the control in the case (II) has an advantage that the ON fixation can be detected solely by the S&S ECU 80, even if the surroundings monitoring ECU 60 is at fault. When the notification fixation flag F is set to ON, a warning lamp provided on an instrument panel, for example, may be turned on or flickered.

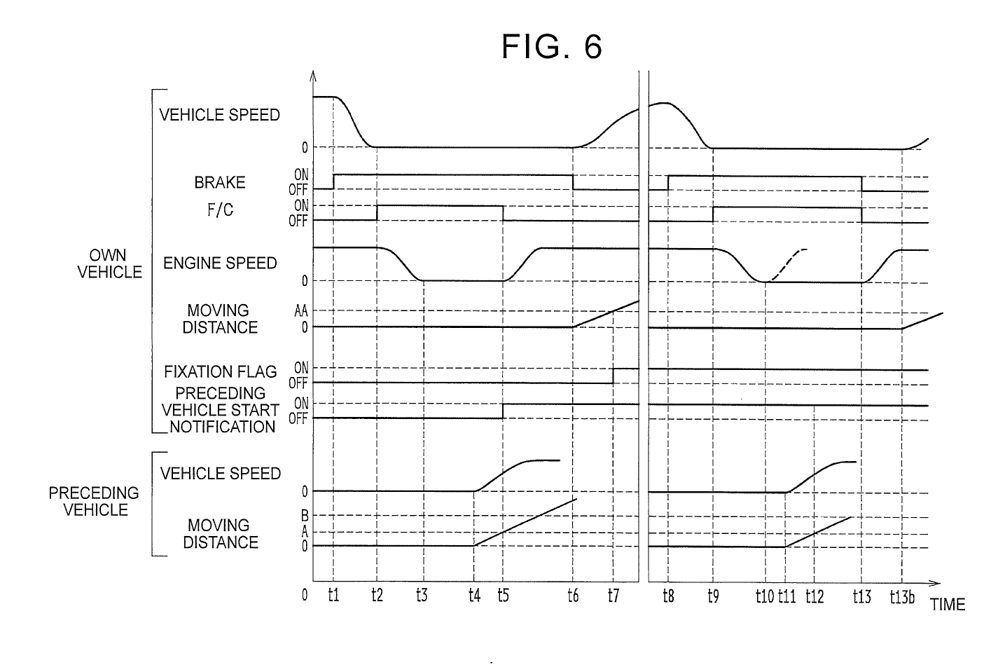

FIG. 6 is a time chart schematically showing one example of automatic stop and restart control at the time of ON fixation. As shown in FIG. 6, the notifying function is normally activated as in the case of FIG. 4 above, until time t6 at which the vehicle 1 starts. However, since the preceding vehicle start notification output is kept in the ON state even when the traveling distance Y of the own vehicle 1 becomes equal to the third predetermined distance AA at time t7, the notification fixation flag F is set to ON. Once the notification fixation flag F is set to ON, the synchronous restart function is restricted; therefore, the engine 2 is not restarted at the same time that the engine 2 automatically stops, as indicated by a thick broken line at time t10. Thus, the fuel efficiency can be prevented from being deteriorated due to the brief automatic stop of the engine. Then, if the brake is set to OFF at time t13, and the normal restart conditions are fulfilled, the engine 2 restarts, and the vehicle 1 starts at time t13b (>t13).

Further, the electronic control unit 10 is configured to detect the delayed ON fixation or the OFF fixation (notification fixation), in the case (III) where the preceding vehicle start notification output is OFF even when the intervehicular distance X between the own vehicle 1 that is stopped and the preceding vehicle 100 becomes equal to or larger than the second predetermined distance B that is larger than the first predetermined distance A.

For example, the surroundings monitoring ECU 60 sends an error flag to the S&S ECU 80, when the meter ECU 70 does not notify the driver, via the display/buzzer 72, that the preceding vehicle 100 has started (i.e., the preceding vehicle start notification output is OFF), even though the intervehicular distance measured by the millimeter-wave radar 62, etc., is equal to or larger than the second predetermined distance B. The error flag is sent to the S&S ECU 80 when the intervehicular distance X is equal to or larger than the second predetermined distance B, rather than the first predetermined distance A, for the following reasons. For one thing, if the intervehicular distance X is equal to or larger than the first predetermined distance A, a sufficient engine automatic stop period is ensured, unlike the cases of the early ON fixation and ON fixation. Also, if the preceding vehicle start notification output is set to ON when the intervehicular distance X is equal to or larger than the first predetermined distance A and smaller than the second predetermined distance B, the driver is less likely or unlikely to feel strange or uncomfortable, and the engine can be restarted earlier than that in the case where the S&S ECU 80 waits until the normal restart conditions are fulfilled.

When the S&S ECU 80 receives the error flag, it determines detection of the delayed ON fixation or OFF fixation, and sets the notification fixation flag F to ON. While the notification fixation flag is ON, the S&S ECU 80 restricts the synchronous restart function, and inhibits the engine 2 from restarting until the normal restart conditions are fulfilled. When the notification fixation flag F is set to ON, a warning lamp provided on the instrument panel, for example, may be turned on or flickered.

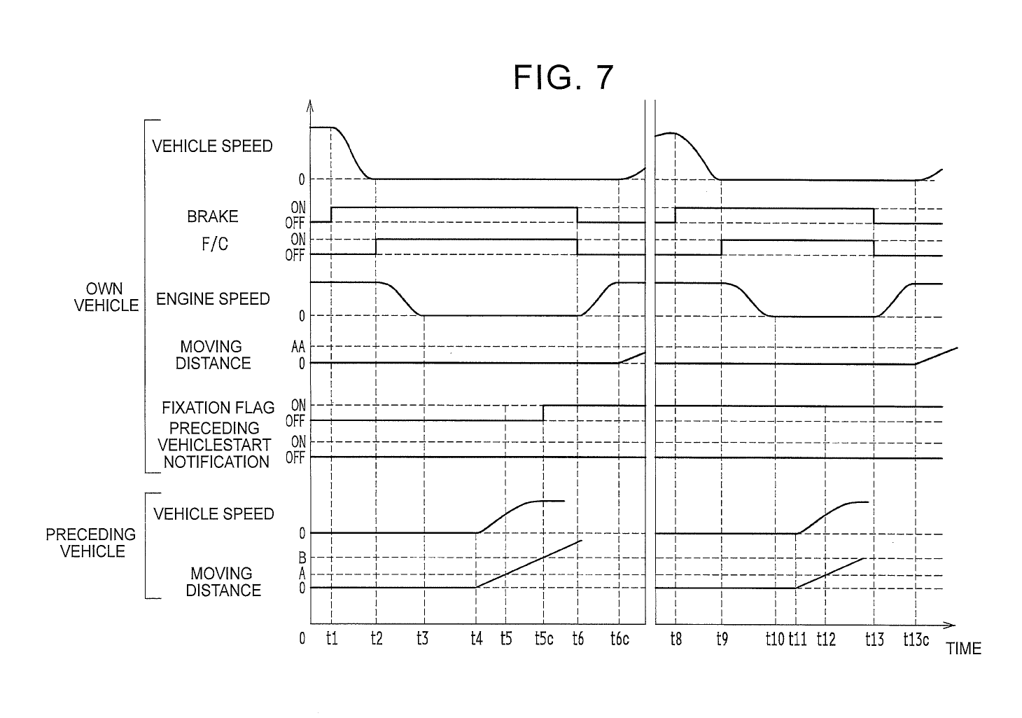

FIG. 7 is a time chart schematically showing one example of automatic stop and restart control at the time of OFF fixation. As shown in FIG. 7, at time t5c (t5<t5c<t6), the notification fixation flag F is set to ON, because the preceding vehicle start notification output is kept in the OFF state even when the intervehicular distance X becomes equal to or larger than the second predetermined distance B. When the notification fixation flag F is set to ON, the synchronous restart function is restricted; therefore, the engine 2 restarts when the brake is placed in the OFF state and the normal restart conditions are fulfilled at time t6 and time t13, and the vehicle 1 starts at time t6c (>t6) and time t13c (>t13). Thus, since the restart of the engine 2 occurs at the same time as the brake-OFF (release) operation by the driver, the driver will be less likely or unlikely to feel strange or uncomfortable, because of delayed restart of the engine caused by the synchronous restart function, or failure to restart the engine.

While the time of cancellation of the notification fixation flag F=ON (i.e., the time of setting of the notification fixation flag F to OFF) is not particularly limited, the cancellation may be effected, for example, (a) when the ignition switch 31 is turned OFF (when one trip is completed), (b) when a predetermined time has elapsed from the time when the notification fixation flag F is set to ON, (c) when the vehicle travels over a given distance since the notification fixation flag F is set to ON, and (d) when recovery from the notification fixation has been confirmed, for example.

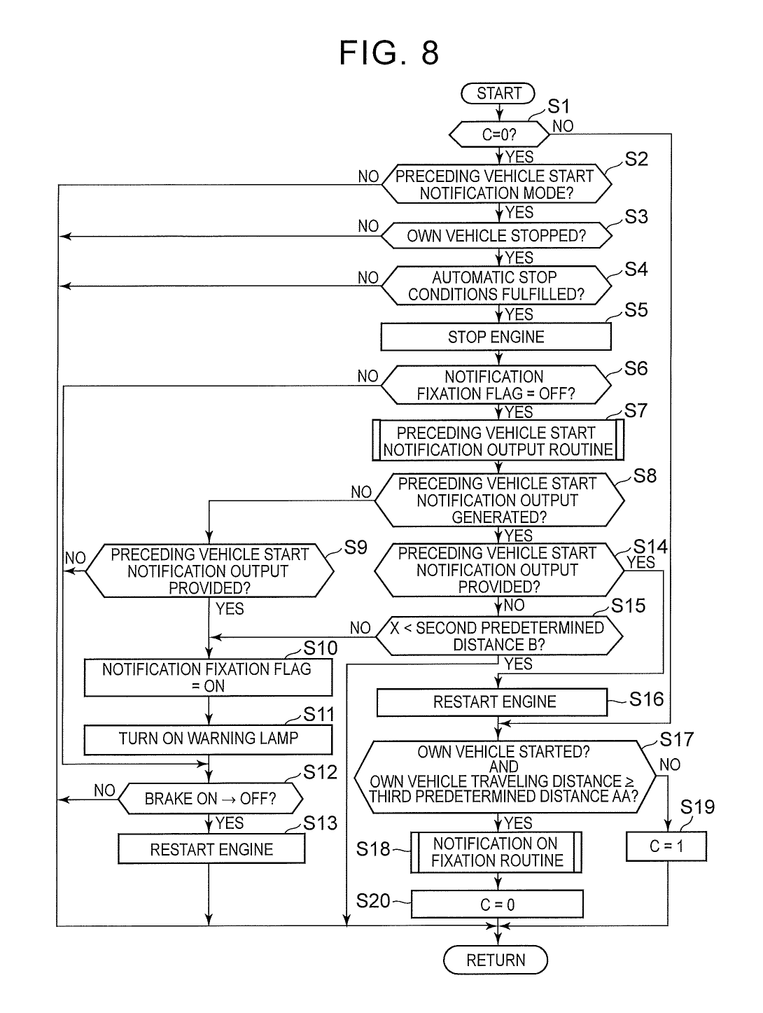

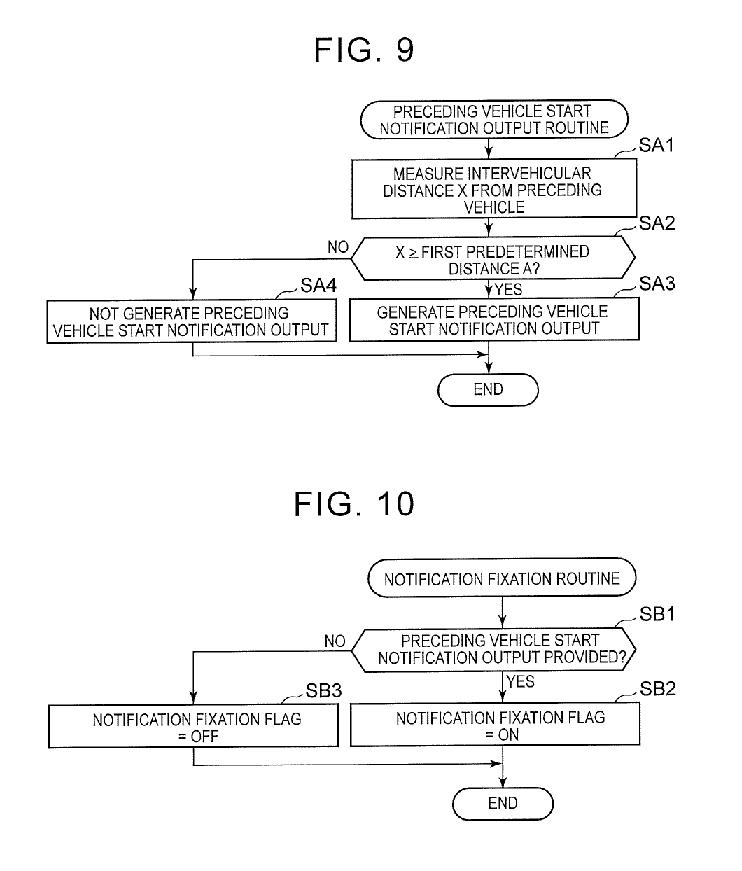

Next, one example of automatic stop and restart control performed by the electronic control unit 10 will be described using the flowcharts shown in FIG. 8 to FIG. 10. The flowchart of FIG. 9 schematically shows one example of a preceding vehicle start notification output routine, and the flowchart of FIG. 10 schematically shows one example of a notification fixation routine. In this flowchart, the notification fixation flag F=ON is cancelled (the notification fixation flag F is set to OFF) when one trip (from ignition ON to ignition OFF) is completed.

Next, automatic stop and restart control at normal times will be described. Initially, in step S1, the electronic control unit 10 (e.g., the S&S ECU 80) determines whether the counter C is equal to zero. While the counter C will be described later, the counter C is equal to zero when the ignition switch 31 is turned ON and this routine is started (“START”). Therefore, an affirmative decision (YES) is obtained in step S1, and the control proceeds to step S2.

In step S2, the electronic control unit 10 (e.g., the meter ECU 70 or the S&S ECU 80) determines whether the vehicle is in a preceding vehicle start notification mode. If a negative decision (NO) is obtained in step S2, in other words, if the mode selection switch 71 is placed in the OFF position through operation of the driver (if the preceding vehicle start notification mode is not selected), this is not the case to which the disclosure is applied, and the control goes to “RETURN” without executing further steps. On the other hand, if an affirmative decision (YES) is obtained in step S2, in other words, if the mode selection switch 71 is placed in the ON position through operation of the driver (if the preceding vehicle start notification mode is selected), the control proceeds to step S3.

In step S3, the electronic control unit 10 (the S&S ECU 80) determines whether the own vehicle 1 has stopped, based on signals from the wheel speed sensors 34, for example. If a negative decision (NO) is obtained in step S3, in other words, if the own vehicle 1 is traveling, the control goes to “RETURN” without executing further steps. On the other hand, if an affirmative decision (YES) is obtained in step S3, the control proceeds to step S4.

In step S4, the electronic control unit 10 (the S&S ECU 80) determines whether the automatic stop conditions are fulfilled. If a negative decision (NO) is obtained in step S4, the control goes to “RETURN” without executing further steps. On the other hand, if an affirmative decision (YES) is obtained in step S4, the control proceeds to step S5, in which the S&S ECU 80 sends an engine stop command to the engine ECU 30, so as to execute fuel cut control and stop the engine 2. Then, the control proceeds to step S6.

In step S6, the electronic control unit 10 (the S&S ECU 80) determines whether the notification fixation flag F is OFF. Since the notification fixation flag F is OFF when the ignition switch 31 is turned ON and this routine is started (“START”), an affirmative decision (YES) is obtained in step S6, and the control proceeds to step S7, to make a transition to the preceding vehicle start notification output routine.

In the preceding vehicle start notification output routine shown in FIG. 9, initially, in step SA1, the electronic control unit 10 (the surroundings monitoring ECU 60) measures the intervehicular distance X between the own vehicle 1 that is stopped and the preceding vehicle 100, based on the detection signal of the millimeter-wave radar 62, etc., and then proceeds to step SA2.

In step SA2, the electronic control unit 10 (the surroundings monitoring ECU 60) determines whether the intervehicular distance X measured in step SA1 is equal to or larger than the first predetermined distance A set by the driver (or set in advance). If an affirmative decision (YES) is obtained in step SA2, the control proceeds to step SA3. In step SA3, the electronic control unit 10 (the surroundings monitoring ECU 60) outputs a signal indicating that “the preceding vehicle start notification output is generated” to notify the driver that the preceding vehicle 100 has started, and then goes to “END”, to return to the flowchart of FIG. 8.

On the other hand, if a negative decision (NO) is obtained in step SA2, in other words, if the preceding vehicle 100 has not started, or if the intervehicular distance X between the own vehicle 1 that is stopped and the preceding vehicle 100 that has started is smaller than the first predetermined distance A, the control proceeds to step SA4. In step SA4, the electronic control unit 10 (the surroundings monitoring ECU 60) outputs a signal indicating that “the preceding vehicle start notification output is not performed”, and then goes to “END”, to return to the flowchart of FIG. 8.

In the next step S8, it is determined whether the preceding vehicle start notification output is generated. If a negative decision (NO) is obtained in step S8, in other words, if the signal indicating that “the preceding vehicle start notification output is not generated” is output through execution of the preceding vehicle start notification output routine, the control proceeds to step S9. In step S9, the electronic control unit 10 determines whether the preceding vehicle start notification output is provided. More specifically, the surroundings monitoring ECU 60 determines whether the driver is actually notified by the meter ECU 70, via the display/buzzer 72, that the preceding vehicle 100 has started (i.e., whether the preceding vehicle start notification output is ON). Here, since the signal indicating that “the preceding vehicle start notification output is not generated” is output, the preceding vehicle start notification output is OFF if the meter ECU 70 is normal, and a negative decision (NO) is obtained in step S9. Then, the control proceeds to step S12.

In step S12, the electronic control unit 10 (the S&S ECU 80) determines whether the brake has switched from ON to OFF. If an affirmative decision (YES) is obtained in step S12, for example, if the driver who noticed starting of the preceding vehicle 100, even though the intervehicular distance X has not reached the first predetermined distance A, operates the brake pedal 24 to place the brake in the OFF state, so that the normal restart conditions are fulfilled, the control proceeds to step S13. In step S13, the electronic control unit 10 (the S&S ECU 80) sends an engine restart command to the engine ECU 30, so as to start supply of the fuel to the combustion chambers of the engine 2, and cause the starter motor 8 to restart the engine 2. Then, the control goes to “RETURN”. On the other hand, if a negative decision (NO) is obtained in step S12, namely, if the brake pedal 24 is not operated by the driver, the control goes to “RETURN” without executing further steps.

On the other hand, if an affirmative decision (YES) is obtained in step S8, in other words, if the signal indicating that “the preceding vehicle start notification output is generated” is output through execution of the preceding vehicle start notification output routine, the control proceeds to step S14. In step S14, the electronic control unit 10 determines whether the preceding vehicle start notification output is provided. More specifically, the surroundings monitoring ECU 60 determines whether the driver is actually notified by the meter ECU 70, via the display/buzzer 72, that the preceding vehicle 100 has started (i.e., whether the preceding vehicle start notification output is ON). Here, since the signal indicating that “the preceding vehicle start notification output is generated” is output, the preceding vehicle start notification output is ON if the meter ECU 70 is normal, and an affirmative decision (YES) is obtained in step S14. Then, the control proceeds to step S16.

In step S16, since the preceding vehicle start notification output is set to ON by the meter ECU 70, so that the notification restart condition is satisfied, the electronic control unit 10 (the S&S ECU 80) sends an engine restart command to the engine ECU 30, so as to start supply of the fuel to the combustion chambers of the engine 2, and cause the starter motor 8 to restart the engine 2. Then, the control proceeds to step S17.

In step S17, the electronic control unit 10 (the S&S ECU 80) determines whether the own vehicle 1 has started, and the traveling distance Y of the own vehicle 1 is equal to or larger than the third predetermined distance AA, based on the signals from the wheel speed sensors 34, for example. If a negative decision (NO) is obtained in step S17, the control proceeds to step S19, in which the electronic control unit 10 (the S&S ECU 80) sets the counter C to 1 (C=1). Then, the control goes to “RETURN”. In step S1 following “RETURN”, the electronic control unit 10 (the S&S ECU 80) determines whether the counter C is 0 (C=0). Now that the counter C is 1 (C=1), a negative decision (NO) is obtained in step S1, and the control proceeds to step S17. In this manner, the determination of step S17 is repeatedly made, until the own vehicle 1 starts, and the traveling distance Y becomes equal to or larger than the third predetermined distance AA. Then, if an affirmative decision (YES) is obtained in step S17, the control proceeds to step S18, and makes a transition to the notification ON fixation routine.

In the notification ON fixation routine shown in FIG. 10, initially, in step SB1, the electronic control unit 10 (S&S ECU 80) determines whether the preceding vehicle start notification output is provided (i.e., whether the preceding vehicle start notification output is ON). If an affirmative decision (YES) is obtained in step SB1, in other words, if the preceding vehicle start notification output is ON even though the traveling distance Y is equal to or larger than the third predetermined distance AA, the control proceeds to step SB2, in which the electronic control unit 10 (the S&S ECU 80) sets the notification fixation flag F to ON (F=ON). Then, the control goes to “END”, and returns to the flowchart of FIG. 8. On the other hand, if a negative decision (NO) is obtained in step SB1, in other words, if the preceding vehicle start notification output is normally set to OFF when the traveling distance Y is equal to or larger than the third predetermined distance AA, the control proceeds to step SB3, in which the electronic control unit 10 (the S&S ECU 80) sets the notification fixation flag F to OFF (F=OFF), and the control goes to “END”, and returns to the flowchart of FIG. 8. In the next step S20, the electronic control unit 10 (the S&S ECU 80) sets the counter C to 0 (C=0), and then goes to “RETURN”.

The flow of control starting with an affirmative decision (YES) in step S8→an affirmative decision (YES) in step S14→engine restart in step S16→an affirmative decision (YES) in step S17, and ending with the notification fixation flag F=OFF in the notification ON fixation routine, as described above, corresponds to the automatic stop and restart control at normal times from time t1 to time t7 shown in FIG. 4.

Then, in step S1 following “RETURN”, since the counter C is 0 (C=0), an affirmative decision (YES) is obtained in step S1. When the notification fixation flag F is set to OFF (F=OFF) in the notification ON fixation routine, an affirmative decision (YES) is obtained in step S6; therefore, at the time of the next automatic stop of the engine, the automatic stop and restart control at normal times, from time t8 to time t14 shown in FIG. 4, is performed.

Next, the automatic stop and restart control at the time of the early ON fixation will be described. In the routine of FIG. 8 above, if an affirmative decision (YES) is obtained in step S9, in other words, if the driver is notified of starting of the preceding vehicle 100 via the display/buzzer 72, even though a signal indicating that “the preceding vehicle start notification output is not generated” is output because the preceding vehicle 100 has not started, for example, the surroundings monitoring ECU 60 sends an error flag to the S&S ECU 80, and then the control proceeds to step S10.

In step S10, the S&S ECU 80 that has received the error flag sets the notification fixation flag F to ON (F=ON), and then proceeds to step S11, to turn on a warning lamp. Then, the control proceeds to step S12.

In step S12, the electronic control unit 10 (the S&S ECU 80) determines whether the brake has been switched from ON to OFF. If a negative decision (NO) is obtained in step S12, the control goes to “RETURN” without executing further steps. Since the notification fixation flag F is set to ON (F=ON) in step S10, a negative decision (NO) is obtained in step S6 in cycles following “RETURN”, and the control proceeds to step S12. In this manner, the determination of step S12 is repeatedly made until the brake is switched from ON to OFF, in other words, until the normal restart conditions are fulfilled. Then, if an affirmative decision (YES) is obtained in step S12, the control proceeds to step S13, in which the S&S ECU 80 restarts the engine 2, and then goes to “RETURN”.

The notification fixation flag F=ON is not cancelled (the notification fixation flag F is not set to OFF) until one trip is completed; therefore, when the engine is automatically stopped in the next and subsequent cycles, a negative decision (NO) is always obtained in step S6, and the control proceeds to step S12.

The flow of control starting with a negative decision (NO) in step S8→an affirmative decision (YES) in step S9→notification fixation flag F=ON in step S10→an affirmative decision (YES) in step S12, and ending with engine restart in step S13, as described above, corresponds to the automatic stop and restart control at the time of occurrence of the early ON fixation shown in FIG. 5 above.

Next, the automatic stop and restart control at the time of ON fixation will be described. Even when the engine is normally restarted through the flow of control starting with an affirmative decision (YES) in step S8→an affirmative decision (YES) in step S14, and ending with engine restart in step S16, the preceding vehicle start notification output may be held ON even though the traveling distance Y is equal to or larger than the third predetermined distance AA. In this case, the notification fixation flag F is set to ON (F=ON) in step SB2 of the notification ON fixation routine. Therefore, when the engine is automatically stopped next time, a negative decision (NO) is obtained in step S6 in cycles following “RETURN”, and the control proceeds to step S12. Then, the determination of step S12 is repeatedly made until the normal restart conditions are fulfilled. This flow corresponds to the automatic stop and restart control at the time of occurrence of the ON fixation shown in FIG. 6 above.

Next, the automatic stop and restart control at the time of delayed ON fixation and OFF fixation will be described A negative decision (NO) is obtained in step S14, when the driver is actually not notified of starting of the preceding vehicle 100 via the display/buzzer 72, namely, the preceding vehicle start notification output is OFF, even though a signal indicating that “the preceding vehicle start notification output is generated” is output according to the preceding vehicle start notification output routine. In this case, namely, when a negative decision (NO) is obtained in step S14, the control proceeds to step S15.

In step S15, the electronic control unit 10 (the surroundings monitoring ECU 60) determines whether the intervehicular distance X measured in step SA1 of the preceding vehicle start notification output routine is smaller than the second predetermined distance B set by the driver (or set in advance). If a negative decision (NO) is obtained in step S15, namely, if the intervehicular distance X between the own vehicle 1 that is stopped and the preceding vehicle 100 that started is equal to or larger than the second predetermined distance B, the surroundings monitoring ECU 60 sends an error flag to the S&S ECU 80, and then proceeds to step S10.

In step S10, the S&S ECU 80 that has received the error flag sets the notification fixation flag F to ON (F=ON), and then proceeds to step S11, to turn on a warning lamp. Then, the control proceeds to step S12. In step 12, the electronic control unit 10 (the S&S ECU 80) determines whether the brake has been switched from ON to OFF. If an affirmative decision (YES) is obtained in step S12, the control proceeds to step S13, in which the S&S ECU 80 restart the engine 2, and then goes to “RETURN”. Since the notification fixation flag F=ON is not cancelled (the notification fixation flag F is not set to OFF) until one trip is completed, a negative decision (NO) is always obtained in step S6 when the engine is automatically stopped in the next and subsequent cycles, and the control proceeds to step S12.

The flow of control starting with an affirmative decision (YES) in step S8→a negative decision (NO) in step S14→a negative decision (NO) in step S15→the notification fixation flag F=ON in step S10→an affirmative decision (YES) in step S12, and ending with engine restart in step S13, as described above, corresponds to automatic stop and restart control at the time of delayed ON fixation or OFF fixation shown in FIG. 7 above.

When a negative decision (NO) is obtained in step S14 since the preceding vehicle start notification output is OFF even though the signal indicating that “the preceding vehicle start notification output is generated” is output, and an affirmative decision (YES) is obtained in step S15 since the intervehicular distance X is smaller than the second predetermined distance B, the control goes to “RETURN” without executing any further steps. Then, if an affirmative decision (YES) is obtained in step S14 in cycles following “RETURN”, the preceding vehicle start notification output is set to ON when the intervehicular distance X is equal to or larger than the first predetermined distance A and smaller than the second predetermined distance B. Therefore, the control proceeds to step S16, to restart the engine based on fulfillment of the notification restart condition.

Next, a modified example of the first embodiment will be described. In the first embodiment, when the early ON fixation is detected, the synchronous restart function is restricted, and the engine 2 is inhibited from restarting until the normal restart conditions are fulfilled. However, the disclosure is not limited to this arrangement, but it may be determined, only in the initial cycle (when the engine is automatically stopped with the early ON fixation detected), for example, whether the intervehicular distance X from the preceding vehicle 100 becomes equal to or larger than the first predetermined distance A, and the S&S ECU 80 may restart the engine 2 when the intervehicular distance X becomes equal to or larger than the first predetermined distance A, without waiting until the normal restart conditions are fulfilled.

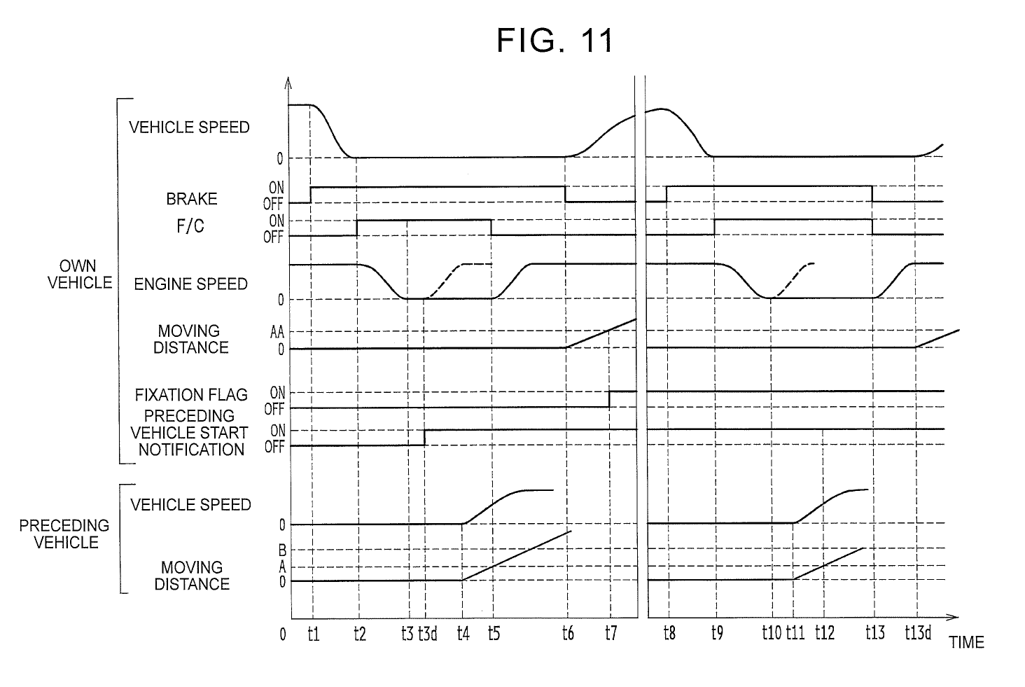

FIG. 11 is a time chart schematically indicating one example of automatic stop and restart control according to the modified example of the first embodiment. As shown in FIG. 11, after the engine 2 is automatically stopped at time t3, even if the preceding vehicle start notification output is set to ON at time t3d (t3<t3d<t4), before time t5 at which the vehicular distance X becomes equal to the first predetermined distance A, this may not be regarded as ON fixation, and therefore, the notification fixation flag F is not set to ON. In this case, since engine restart based on fulfillment of the notification restart condition is restricted, engine restart as indicated by a thick broken line at time t3d does not take place. As a result, the engine automatic stop period is prevented from being shortened, and an opportunity of improvement of fuel efficiency can be ensured.

Then, if the intervehicular distance X becomes equal to the first predetermined distance A at time t5, the engine 2 is restarted. If the preceding vehicle start notification output is kept in the ON state, even when the traveling distance Y of the own vehicle 1 after engine restart becomes equal to the third predetermined distance AA at time t7, there is an extremely high possibility of occurrence of the ON fixation, and the notification fixation flag F is set to ON. Once the notification fixation flag F is set to ON, the synchronous restart function is restricted, and therefore, the engine 2 is not restarted at the same time that the engine 2 automatically stops at time t10. Thus, the fuel efficiency is prevented from being deteriorated due to the brief automatic stop of the engine. Then, if the brake is placed in the OFF state at time t13, and the normal restart conditions are fulfilled, the engine 2 restarts, and the vehicle 1 starts at time t13d (>t13).

Next, a second embodiment of the disclosure will be described. The second embodiment is different from the first embodiment in that a condition that the preceding vehicle start notification output is ON is not used as an engine restart condition. In the following, the same configuration as that of the first embodiment will not be described, and differences from the first embodiment will be mainly described.

In the second embodiment, the S&S ECU 80 is configured to restart the engine 2, in the case where the intervehicular distance X between the own vehicle 1 that is stopped and the preceding vehicle 100 becomes equal to or larger than the first predetermined distance A, as well as the case where the normal restart conditions are fulfilled. Namely, in the second embodiment, a condition that the intervehicular distance X becomes equal to or larger than the first predetermined distance A is used as a condition for restarting the engine 2, no matter whether the preceding vehicle start notification output is ON or OFF.

In this connection, when the intervehicular distance X becomes equal to or larger than the first predetermined distance A, the preceding vehicle start notification output is set to ON; therefore, the automatic stop and restart function of the second embodiment also includes “the synchronous restart function of restarting the engine 2 that is automatically stopped, in synchronization with notification by the notifying function, even when the normal restart conditions are not fulfilled”. Accordingly, the engine 2 is arranged to be restarted, in either of the case (a) where the normal restart conditions are fulfilled, and the case (b) where the intervehicular distance X between the own vehicle 1 and the preceding vehicle 100 becomes equal to or larger than the first predetermined distance A, which occurs at an earlier point in time, after the vehicle 1 is stopped and the engine 2 is automatically stopped. The condition that the intervehicular distance X becomes equal to or larger than the first predetermined distance A may also be called “preceding vehicle start restart condition”, for the sake of convenience in explanation.

Thus, in the second embodiment, the engine is restarted and the preceding vehicle start notification output is set to ON at the same time. Therefore, if the notifying function normally works, it is possible to notify the driver of starting of the preceding vehicle 100, while reducing a delay in start-up upon restart of the engine, as in FIG. 4, even where the driver is not aware that the preceding vehicle 100 has started during stop of the own vehicle. Also, the engine restart based on the automatic stop and restart function and the notification based on the notifying function are controlled independently of each other. Therefore, even if the early ON fixation or the ON fixation as shown in FIG. 13 above occurs, the fuel efficiency will not deteriorate due to brief automatic stop of the engine, because the engine 2 is not restarted along with ON (generation) of the preceding vehicle start notification output.

In this connection, when the engine restart based on the automatic stop and restart function and the notification based on the notifying function are controlled independently of each other, the engine restart and ON (generation) of the preceding vehicle start notification output may take place at different times, and the driver may feel strange or uncomfortable. Also, when the delayed ON fixation occurs such that the preceding vehicle start notification output is set to ON with a delay from the time when the intervehicular distance X becomes equal to or larger than the first predetermined distance A, or the OFF fixation occurs such that the preceding vehicle start notification output is kept in the OFF state, contrary to the early ON fixation and the ON fixation, the driver may further feel strange or uncomfortable, as will described below.

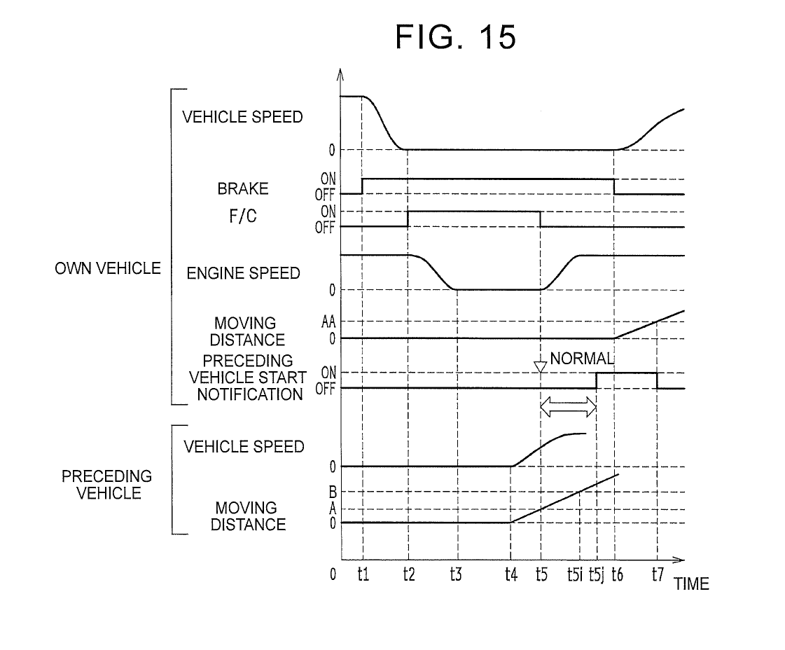

FIG. 15 is a time chart schematically showing one example of automatic stop and restart control at the time of notification fixation. While the preceding vehicle start notification output is originally supposed to be ON, at time t5 when the intervehicular distance X between the own vehicle 1 that is stopped and the preceding vehicle 100 becomes equal to the first predetermined distance A, the delayed ON fixation may occur, and the preceding vehicle start notification output may not be set to ON until time t5j (t5<t5i<t5j<t6) that is later than time t5i at which the intervehicular distance X becomes equal to or larger than the second predetermined distance B. Thus, even when the notification is delayed from normal (time t5) by an amount indicated by the blank arrow in FIG. 15, the engine is restarted at time t5 at which the intervehicular distance X becomes equal to the first predetermined distance A. In this case, the driver may strongly feel strange or uncomfortable since he/she is not operating the brake pedal 24, and the engine is restarted even in the absence of the notification.

In the second embodiment, when notification fixation with which the preceding vehicle start notification output is placed in the ON state or OFF state in a situation other than a predetermined situation, the synchronous restart function of restarting the engine 2 when the intervehicular distance X between the own vehicle 1 that is stopped and the preceding vehicle 100 becomes equal to the first predetermined distance A is restricted, and the engine 2 is inhibited from restarting until the normal restart conditions are fulfilled, in order to deal with the above-described events.

More specifically, the electronic control unit 10 is configured to detect notification fixation, in the case where the preceding vehicle start notification output is set to ON even though the intervehicular distance X is smaller than the first predetermined distance A, the case where the preceding vehicle start notification output is kept in the ON state, even when the traveling distance Y after engine restart becomes equal to or larger than the third predetermined distance AA, and the case where the preceding vehicle start notification output is OFF even when the intervehicular distance X becomes equal to or larger than the second predetermined distance B that is larger than the first predetermined distance A.

For example, when the meter ECU 70 does not notify the driver, via the display/buzzer 72, that the preceding vehicle 100 has started, namely, when the preceding vehicle start notification output is OFF, even though the intervehicular distance X measured with the millimeter-wave radar 62, etc., is equal to or larger than the second predetermined distance B, the surroundings monitoring ECU 60 sends an error flag to the S&S ECU 80.

When the S&S ECU 80 receives the error flag, it determines that the delayed ON fixation or the OFF fixation is detected, and sets the notification fixation flag F to ON. While the notification fixation flag F is ON, the S&S ECU 80 restricts the synchronous restart function, and inhibits the engine 2 from restarting until the normal restart conditions are fulfilled. When the notification fixation flag F is set to ON, a warning lamp provided on the instrument panel may be turned on or flickered, for example.

Here, if the intervehicular distance X is equal to or larger than the first predetermined distance A, a sufficient engine automatic stop period is ensured. Also, if the preceding vehicle start notification output is set to ON while the intervehicular distance X is smaller than the second predetermined distance B, the engine can be restarted at an earlier opportunity than that in the case where the S&S ECU 80 waits until the normal restart conditions are fulfilled, and the driver is less likely or unlikely to feel strange or uncomfortable. Thus, in the second embodiment, if the preceding vehicle start notification output is set to ON when the intervehicular distance X is equal to or larger than the first predetermined distance A and smaller than the second predetermined distance B, the S&S ECU 80 is configured to restart the engine 2 that is automatically stopped, even if the normal restart conditions are not fulfilled.

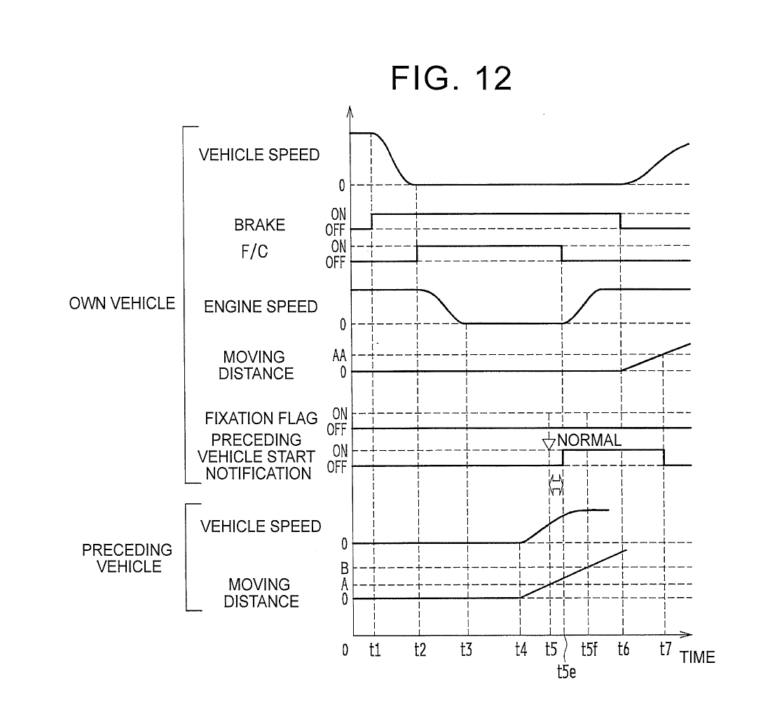

FIG. 12 is a time chart schematically showing one example of automatic stop and restart control according to the second embodiment. In the second embodiment, when the preceding vehicle start notification output is set to ON, at time t5e between time t5 at which the intervehicular distance X becomes equal to the first predetermined distance A, and time t5f at which the intervehicular distance X becomes equal to the second predetermined distance B, the S&S ECU 80 restarts the engine 2, without waiting for fulfillment of the normal restart conditions. In this case, the engine restart is delayed from normal (time t5) by an amount indicated by the blank arrow in FIG. 12. However, the engine can be restarted at an earlier opportunity than that in the case where the S&S ECU 80 waits until the normal restart conditions are fulfilled, and the driver is less likely or unlikely to feel strange or uncomfortable because there is substantially no difference between the time of engine restart and the ON time of the preceding vehicle start notification output.

Next, a modified example of the second embodiment will be described. In the second embodiment, notification fixation is detected, when the preceding vehicle start notification output is OFF even when the intervehicular distance X becomes equal to or larger than the second predetermined distance B that is larger than the first predetermined distance A. However, when there arises a malfunction in a system for measuring the intervehicular distance X between the own vehicle 1 and the preceding vehicle 100, it may be difficult to detect notification fixation.

Thus, in the modified example, the electronic control unit 10 is configured to set the notification fixation flag F to ON, when the traveling distance Y of the own vehicle 1 after engine restart becomes equal to or larger than the third predetermined distance AA, in a condition where the notification output based on the notifying function is in the OFF state. More specifically, the S&S ECU 80 can measure the traveling distance Y of the own vehicle 1 after engine restart, based on the detection results from the wheel speed sensors 34, etc., for example. Therefore, if the preceding vehicle start notification output is kept in the OFF state until the traveling distance Y becomes equal to or larger than the third predetermined distance AA, the S&S ECU 80 determines that the OFF fixation is detected, and sets the notification fixation flag F to ON, even if it does not receive an error flag from the surroundings monitoring ECU 60.

With the above configuration, when it is difficult to detect notification fixation, based on the first predetermined distance A and the second predetermined distance B, it is possible to detect notification fixation without fail, based on the traveling distance Y of the own vehicle 1.

Next, other embodiments of the disclosure will be described. This disclosure is not limited to the above embodiments, but may be embodied in various other forms, without departing from the spirit or principal features of the disclosure.

While ECUs that make determinations and output signals are illustrated by way of example, in the electronic control unit 10, an ECU or ECUs other than the ECUs illustrated in the above embodiments may make determinations and output signals.

While this disclosure is applied to the vehicle 1 that includes the gasoline engine as the engine 2, and includes the multi-speed transmission as the automatic transmission 4, in each of the above embodiments, this disclosure may also be applied to a vehicle including a diesel engine, or a vehicle including a belt-type continuously variable transmission.

While this disclosure is applied to the so-called conventional vehicle 1 on which only the engine 2 is installed as a drive source, this disclosure is not limitedly applied to this type of vehicle, but may also be applied to other types of vehicles, provided that the vehicle includes the engine 2 as a drive source. For example, the disclosure may be applied to a so-called hybrid vehicle including a motor-generator as a drive source, in addition to the engine 2.

While the ON or OFF state of the brake is detected based on the detection result of the M/C pressure sensor 82 in each of the above embodiments, the disclosure is not limited to this arrangement, but a brake switch may be used which is placed in an ON state when the amount of depression of the brake pedal 24 exceeds a threshold value, and is placed in an OFF state when the depression amount is equal to or smaller than the threshold value.

Thus, each of the above-described embodiments is merely an illustrative example in all respects, and should not be limitedly interpreted. Further, modifications or changes that are within the range of equivalents of the appended claims are all within the range of the disclosure.

According to this disclosure, the starting assistance is performed in appropriate timing, and the instability with which the engine is restarted can be reduced.

Therefore, the disclosure is considerably useful when it is applied to an electronic control unit of a vehicle having an automatic stop and restart function and a notifying function.

What is claimed is:

1. A control system of a vehicle, comprising:
an electronic control unit configured to:
(i) have an automatic stop and restart function to automatically stop an engine when a predetermined automatic stop condition is fulfilled, and restart the engine when a predetermined restart condition is fulfilled during automatic stop of the engine, and
(ii) have a notifying function to notify a driver of an own vehicle that a preceding vehicle has started, by setting notification output to ON when an intervehicular distance between the own vehicle that is stopped and the preceding vehicle becomes equal to or larger than a first predetermined distance, wherein:
the automatic stop and restart function includes a synchronous restart function, and
the electronic control unit is configured to restrict the synchronous restart function, and inhibit the engine from restarting until the predetermined restart condition is fulfilled, when notification fixation with which the notification output is placed in an ON state or an OFF state in a situation other than a preset setting situation is detected, the synchronous restart function being a function of restarting the engine that is automatically stopped, in synchronization with notification by the notifying function, even when the predetermined restart condition is not fulfilled.

2. The control system according to claim 1, wherein the electronic control unit, when performing the synchronous restart function, is configured to:
(i) restart the engine when the notification output by the notifying function is set to ON, and
(ii) detect the notification fixation, when the notification output is set to ON, even though the intervehicular distance between the own vehicle that is stopped and the preceding vehicle is smaller than the first predetermined distance.

3. The control system according to claim 1, wherein the electronic control unit, when performing the synchronous restart function, is configured to:
(i) restart the engine when the notification output by the notifying function is set to ON, and
(ii) detect the notification fixation, when the notification output is kept in the ON state even when a traveling distance of the own vehicle after restart of the engine becomes equal to or larger than a third predetermined distance.

4. The control system according to claim 1, wherein the electronic control unit, when performing the synchronous restart function, is configured to:
(i) restart the engine when the notification output by the notifying function is set to ON, and
(ii) detect the notification fixation, when the notification output by the notifying function is OFF even when the intervehicular distance between the own vehicle that is stopped and the preceding vehicle becomes equal to or larger than a second predetermined distance that is larger than the first predetermined distance.

5. The control system according to claim 1, wherein the electronic control unit, when performing the synchronous restart function, is configured to:
(i) restart the engine when the intervehicular distance between the own vehicle that is stopped and the preceding vehicle becomes equal to or larger than the first predetermined distance, and
(ii) detect the notification fixation, when the notification output by the notifying function is OFF even when the intervehicular distance between the own vehicle that is stopped and the preceding vehicle becomes equal to or larger than a second predetermined distance that is larger than the first predetermined distance.

6. The control system according to claim 5, wherein the electronic control unit is configured to:
(i) set a flag when the notification fixation is detected, and
(ii) set the flag, when a traveling distance of the own vehicle after restart of the engine becomes equal to or larger than a third predetermined distance, in a condition where the notification output by the notifying function is OFF.

7. The control system according to claim 1, wherein the electronic control unit, when performing the synchronous restart function, is configured to:
(i) restart the engine, when the intervehicular distance between the own vehicle (1) that is stopped and the preceding vehicle becomes equal to or larger than the first predetermined distance, and
(ii) restart the engine that is automatically stopped, even though the predetermined restart condition is not fulfilled, when the notification output is kept in the OFF state even when the intervehicular distance between the own vehicle that is stopped and the preceding vehicle becomes equal to the first predetermined distance, and the notification output is set to ON when the intervehicular distance between the own vehicle and the preceding vehicle is smaller than a second predetermined distance that is larger than the first predetermined distance.

8. A control method of a control system of a vehicle, comprising:
(i) automatically stopping an engine when a predetermined automatic stop condition is fulfilled, and restarting the engine when a predetermined restart condition is fulfilled during automatic stop of the engine;
(ii) notifying a driver of an own vehicle that a preceding vehicle has started, by setting notification output to ON when an intervehicular distance between the own vehicle that is stopped and the preceding vehicle becomes equal to or larger than a first predetermined distance;
(iii) performing a synchronous restart function of restarting the engine that is automatically stopped, in synchronization with notification by the notifying function, even when the predetermined restart condition is not fulfilled; and
(iv) restricting the synchronous restart function, and inhibiting the engine from restarting until the predetermined restart condition is fulfilled, when notification fixation with which the notification output is placed in an ON state or an OFF state in a situation other than a preset setting situation is detected.
